(19) United States
(12) Patent Application Publication
(10) Pub. No.: US 2015/0094203 A1
(43) Pub. Date: Apr. 2, 2015

(54) METHOD OF CONTROLLING PESTS

(71) Applicant: SUMITOMO CHEMICAL COMPANY, LIMITED, Tokyo (JP)

(72) Inventor: Hajime IKEDA, Kasai-shi (JP)

(73) Assignee: SUMITOMO CHEMICAL COMPANY, LIMITED, Tokyo (JP)

(21) Appl. No.: 14/043,421

(22) Filed: Oct. 1, 2013

(51) Int. Cl. A01N 43/84; A01N 43/653; A01N 33/22; A01N 25/00; A01N 43/54; A01N 41/06

(52) U.S. Cl. CPC A01N 43/84; A01N 43/54; A01N 41/06; A01N 33/22; A01N 25/00; A01N 43/653
USPC 504/225; 504/243; 504/333; 504/352; 504/273

(57) ABSTRACT

The present invention relates to a method of controlling pests such as weeds in a soybean field, corn field, or cotton field.

According to the present invention, pests in soybean fields, corn fields, or cotton fields can be efficiently controlled.

### BACKGROUND OF THE INVENTION

1. Field of the Invention

The present invention relates to a pest control method, that is, a method of controlling pests such as harmful arthropod pests, nematodes, plant pathogens, and/or weeds.

2. Description of the Related Art

Various compounds are known as effective components for insecticides, nematicides, or fungicides. Also, protoporphyrinogen IX oxidase (hereinafter abbreviated as PPO) inhibiting compounds are known as effective components for herbicides.

### PRIOR ART DOCUMENTS

### Patent Documents

Patent Document 1: WO 95/027693
Patent Document 2: WO 06/062978
Patent Document 3: WO 08/072783

### Non-Patent Documents

Non-patent Document 1: Crop Protection Handbook, vol. 98 (2012) Meister Publishing Company, ISBN: 1-892829-25-8)
Non-patent Document 2: Compendium of Pesticide Common Names (http://www.alanwood.net/pesticides/)

### SUMMARY OF THE INVENTION

It is an object of the present invention to provide a method for producing an excellent effect on pest control in a soybean field, corn field, or cotton field.

The present invention relates to a method of controlling pests grown in a field by treating a corn field, soybean field, or cotton field with one or more PPO-inhibiting compounds before sowing, at the same time of sowing, or after sowing corn seeds, soybean seeds, or cotton seeds which are treated with two or more specific insecticidal compounds, nematicidal compounds, and fungicidal compounds.

The present invention is as follows.

[1] A method of controlling weeds in a soybean field, corn field, or cotton field, the method comprising treating the soybean field, corn field, or cotton field with one or more PPO-inhibiting compounds selected from flumioxazin, sulfentrazone, saflufenacil, oxyfluorfen and fomesafen-sodium, before sowing, at the same time of sowing, or after sowing corn seeds, soybean seeds, or cotton seeds which are treated with two or more compounds selected from the following compound group A:

Compound group A: neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators.

[2] A method of controlling pests in a soybean field, corn field, or cotton field, the method comprising the steps of:
treating soybean seeds, corn seeds, or cotton seeds with two or more compounds selected from the following compound group A:
   Compound group A: neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators; and
treating the field with one or more PPO-inhibiting compounds selected from flumioxazin, sulfentrazone, saflufenacil, oxyfluorfen and fomesafen-sodium, before sowing, at the same time of sowing, or after sowing corn seeds, soybean seeds, or cotton seeds which are treated with the compounds of the compound group A.

[3] The control method according to [2], wherein the pests are weeds.

[4] The control method according to [1] to [3], wherein two or more compounds selected from the compound group A is two or more compounds selected from the following compound group A-1.

### Compound Group A-1:

neonicotinoid compounds: clothianidin, thiamethoxam, imidacloprid, dinotefuran, nitenpyram, acetamiprid, and thiacloprid;
diamide compounds: flubendiamide, chlorantraniliprole, cyantraniliprole, and compounds represented by the formula (I):

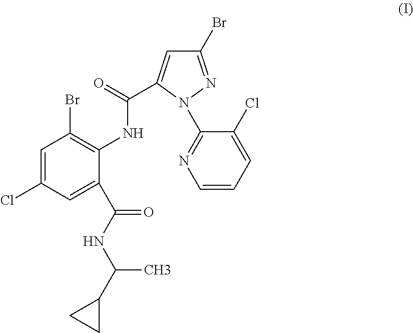 [SMILES: CC(NC(=O)c1cc(Cl)cc(Br)c1NC(=O)c1cc(Br)nn1-c1ncccc1Cl)C1CC1]

carbamate compounds: aldicarb, oxamyl, thiodicarb, carbofuran, carbosulfan, and dimethoate;
organic phosphorous compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
biological nematicidal compounds: Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;
other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
azole compounds: azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizole;
strobilurin compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxy)methyl]phenyl-2-methoxy-acetamide (racemic or enantiomer, containing a mixture of R-enantiomer and S-enantiomer (optional ratio));
metalaxyl compounds: metalaxyl and metalaxyl-M;
SDHI compounds: sedaxane, penflufen, carboxin, boscalid, furametpyr, flutolanil, fluxapyroxad, isopyrazam, fluopyram, and thifluzamide;
other fungicidal compounds: tolclophos-methyl, thiram, captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
plant growth regulators: ethephon, chlormequat-chloride, mepiquat-chloride, and 4-oxo-4-(2-phenylethyl)aminobutyric acid.

[5] The control method according to anyone of [1] to [4], the method comprising the step of treating the field with the PPO-inhibiting compound before the soybean seeds, corn seeds, or cotton seeds are sowed.

[6] The control method according to anyone of [1] to [4], the method comprising the step of treating the field with the PPO-inhibiting compound at the same time of sowing the soybean seeds, corn seeds, or cotton seeds.

[7] The control method according to anyone of [1] to [4], the method comprising the step of treating the field with the PPO-inhibiting compound after the soybean seeds, corn seeds, or cotton seeds are sowed.

Pests in soybean fields, corn fields, or cotton fields can be controlled by the method of controlling pests according to the present invention.

### DETAILED DESCRIPTION OF THE PREFERRED EMBODIMENTS

A method of controlling pests according to the present invention includes the steps of:
(1) treating soybean seeds, corn seeds, or cotton seeds with two or more compounds selected from a compound group A including specific insecticidal compounds, nematicidal compounds, and fungicidal compounds; and
(2) treating a field with at least one PPO-inhibiting compound selected from flumioxazin, sulfentrazone, saflufenacil, oxyfluorfen and fomesafen-sodium, before sowing, at the same time of sowing, or after sowing corn seeds, soybean seeds, or cotton seeds which are treated with the compounds of the compound group A.

As the soybean seeds, corn seeds, or cotton seeds used in the present invention, any kind of soybean, corn, or cotton seed may be used without any particular limitation insofar as it is a variety cultivated as a general crop.

This variety of plants includes plants to which resistance to PPO-inhibiting compounds such as flumioxazin; 4-hydroxyphenylpyrubic acid dioxygenase inhibitors such as isoxaflutole; acetolactate synthase (hereinafter abbreviated as ALS) inhibitors such as imazethapyr and thifensulfuron-methyl; 5-enolpyruvylshikimate-3-phosphoric acid synthase inhibitors such as glyphosate; glutamine synthetase inhibitors such as glufosinate; auxin herbicides such as 2,4-D and dicamba; and herbicides such as bromoxinyl are imparted by classical breeding methods or genetic modification technologies.

As examples of crops to which resistance has been imparted by classical breeding methods, corn resistant to imidazolinone ALS inhibitory herbicides such as imazethapyr is given and has already been commercially available under the trade name of Clearfield (trademark). Examples of such crops include STS soybeans resistant to sulfonylurea ALS inhibitory herbicides such as thifensulfuron-methyl; and the like. Similarly, examples of a plant to which resistance to an acetyl CoA carboxylase inhibitor such as trione oxime-based or aryloxyphenoxypropionic acid-based herbicide has been imparted by classical breeding methods include SR corn.

Examples of a plant to which resistance has been imparted by genetic modification technologies include corn, soybeans and cotton resistant to glyphosate, and they have already been commercially available under the trade names of RoundupReady (registered trade mark), Agrisure (registered trademark) GT, Gly-Tol (registered trademark) and the like. Similarly, there are corn, soybeans and cotton resistant to glufosinate by genetic modification technologies, and they have already been commercially available under the trade names of LibertyLink (registered trademark) and the like. There are varieties of corn and soybeans under the trade names of Optimum (registered trademark) and GAT (registered trade mark), which are resistant to both of glyphosate and ALS inhibitor. Similarly, there are soybeans resistant to imidazolinone ALS inhibitors by genetic modification technologies, and they have been developed under the name of Cultivance. Similarly, there is cotton resistant to bromoxynil by genetic modification technologies, and this has already been commercially available under the trade name of BXN (registered trademark). Similarly, there is a variety of soybean sold under the trade name of RoundupReady (registered trademark) 2 Xtend as a soybean resistant to both of glyphosate and dicamba by genetic modification technologies. Similarly, there has been developed cotton resistant to both of glyphosate and dicamba by genetic modification technologies.

A gene encoding aryloxyalkanoate dioxygenase may be introduced to produce a crop which becomes resistant to phenoxy acid herbicides such as 2,4-D, MCPA, dichlorprop and mecoprop, and aryloxyphenoxypropionic acid herbicidessuchasquizalofop, haloxyfop, fluazifop, diclofop, fenoxaprop, metamifop, cyhalofop and clodinafop (Wright et al. 2010: Proceedings of National Academy of Science. 107 (47): 20240-20245). Cultivars of soybean and cotton, which show the resistance to 2,4-D, have been developed under the brand of Enlist.

The above crops include, for example, crops which can synthesize selective toxins and the like known as the genus Bacillus by using genetic modification technologies.

Examples of the toxins developed in such genetically modified plants include insecticidal proteins derived from Bacillus cereus and Bacillus popilliae; 8-endotoxins such as Cry1Ab, Cry1Ac, Cry1F, Cry1Fa2, Cry2Ab, Cry3A, Cry3Bb1, Cry9C, Cry34ab and Cry35ab derived from Bacillus thuringiensis; insecticidal proteins such as VIP1, VIP2, VIP3, and VIP3A; insecticidal proteins derived from nematodes; toxins produced by animals such as scorpion toxins, spider toxins, bee toxins, and neurotoxins specific to insects; filamentous fungus toxins; plant lectins; agglutinin; trypsin inhibitors, serine protease inhibitors, and protease inhibitors such as patatin, cystatin, and papain inhibitors; ribosome inactivating proteins (RIP) such as lysine, corn-RIP, abrin, lufin, saporin, andbryodin; steroid metabolic enzymes such as 3-hydroxysteroid oxidase, ecdysteroid-UDP-glucosyltransferase, and cholesterol oxidase; ecdysone inhibitors; HMG-CoA reductase; ion channel inhibitors such as sodium channel and calcium channel inhibitors; juvenile hormone esterase; diuretic hormone receptors; stilbene synthase; bibenzyl synthase; chitinase; and glucanase.

The toxins expressed in these transgenic plants include hybrid toxins, partially deficient toxins and modified toxins, which derive from 5-endotoxin proteins such as Cry1Ab, Cry1Ac, Cry1F, Cry1Fa2, Cry2Ab, Cry3A, Cry3Bb1, Cry9C, Cry34Ab and Cry35Ab, and insecticidal proteins such as VIP1, VIP2, VIP3 and VIP3A. The hybrid toxins are created by new combinations of domains having different proteins by using genetic modification technologies. As the partially defective toxins, Cry1Ab in which part of the amino acid sequences is missing is known. In the modified toxin, one or more of amino acids of a natural type toxin is replaced. Examples of these toxins and geneticallymodifiedplants capable of synthesizing these toxins are described in, for example, EP-A-0374753, WO 93/07278, WO 95/34656, EP-A-0427529, EP-A-451878, and WO 03/052073. Resistance to noxious insects belonging to order Coleoptera, order Diptera, and order Lepidoptera is imparted to plants by toxins contained in these genetically modified plants.

Also, genetically modified plants which contain one or more insecticidal genes resistant to harmful insects and develop one or more toxins have been already known and some of these plants have been put on the market. Examples of these genetically modified plants include YieldGard (registered trademark) (corn variety expressing Cry1Ab toxin), YieldGard Rootworm (registered trademark) (corn variety expressing Cry3Bb1 toxin), YieldGard Plus (registered trademark) (corn variety expressing Cry1Ab and Cry3Bb1 toxins), Herculex I (registered trademark) (corn variety expressing phosphinothricin N-acetyltransferase (PAT) for imparting resistance to a Cry1Fa2 toxin and glufosinate), NatureGard (registered trademark), AGRISURE (registered trademark) CBAdvantage (Bt11 cornborer (CB) trait), Protecta (registered trademark); and the like.

Also, genetically modified cotton which contains one or more insecticidal genes resistant to harmful insects and develops one or more toxins has been already known and some of cotton have been put on the market. Examples of these genetically modified cotton include BollGard (registered trademark) (cotton variety expressing Cry1Ac toxin), BollGard (registered trademark) II (cotton variety expressing Cry1Ac and Cry2Ab toxins), BollGard (registered trademark) III (cotton variety expressing Cry1Ac, Cry2Ab and VIP3A toxins), VipCot (registered trademark) (cotton variety expressing VIP3A and Cry1Ab toxins), WideStrike (registered trademark) (cotton variety expressing Cry1Ac and Cry1F toxins) and the like.

Examples of the plant used in the present invention also include plants such as soybeans into which a Rag1 (Resistance Aphid Gene 1) gene is introduced to impart resistance to an aphid.

The plants to be used in the present invention include those provided with resistance to nematodes by using a classical breeding method or genetic modification technologies. Examples of the genetic modification technologies used to provide the resistance to nematodes include RNAi.

The above crops include those to which the ability to produce antipathogenic substances having a selective effect is imparted using genetic modification technologies. For example, PR proteins are known as an example of the antipathogenic substance (PRPs, EP-A-0392225). Such antipathogenic substances and genetically modified plants producing these antipathogenic substances are described in, for example, EP-A-0392225, WO 95/33818, and EP-A-0353191. Examples of the antipathogenic substances developed in such genetically modified plants include ion channel inhibitors such as a sodium channel inhibitor and calcium channel inhibitor (KP1, KP4, and KP6 toxins produced by virus are known); stilbene synthase; bibenzyl synthase; chitinase; glucanase; PR protein; antipathogenic substances produced by microorganisms such as peptide antibiotics, antibiotics having a heteroring, and a protein factor (referred to as a plant disease resistant gene and described in WO 03/000906) relating to plant disease resistance.

The above crops include plants to which useful traits such as an oil component reformation and amino acid-content reinforcing trait are given by genetic modification technologies. Examples of these plants include VISTIVE (trademark) (low linolenic soybean having a reduced linolenic content), high-lysine (high oil) corn (corn having an increased lysine or oil content) and the like.

Moreover, the above crops include stuck varieties obtained by combining two or more useful traits such as the above classical herbicide trait or herbicide resistant gene, gene resistant to insecticidal noxious insects, antipathogenic substance-producing gene, oil component reformation, and amino acid-content reinforcing trait, and allergen reduction trait.

In the present invention, examples of the compounds of the compound group A including specific insecticidal compounds, nematicidal compounds, and fungicidal compounds, and plant growth regulators used to treat soybean seeds, corn seeds, or cotton seeds include neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators.

Examples of the neonicotinoid compounds in the present invention include the followings:

clothianidin, imidacloprid, nitenpyram, acetamiprid, thiamethoxam, thiacloprid, and dinotefuran.

Examples of the diamide compounds in the present invention include the followings:

flubendiamide, chlorantraniliprole, cyantraniliprole, and compounds represented by the formula (I):

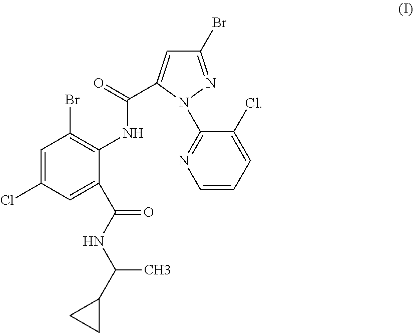 [SMILES: CC(NC(=O)c1cc(Cl)cc(Br)c1NC(=O)c1cc(Br)nn1-c1ncccc1Cl)C1CC1]

Examples of the carbamate compounds in the present invention include the followings:
aldicarb, oxamyl, thiodicarb, carbofuran, carbosulfan, and dimethoate.

Examples of the organic phosphorous compounds in the present invention include the followings:
fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon.

Examples of the biological nematicidal compounds in the present invention include the followings:
Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides.

Examples of the other insecticidal compounds and nematicidal compounds in the present invention include the followings:
fipronil, ethiprole, flupyradifurone, sulfoxaflor, beta-cyfluthrin, tefluthrin, chlorpyrifos, abamectin, spirotetramat, and fluensulfone.

Examples of the azole compounds in the present invention include the followings:
azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, prochloraz, and triflumizole.

Examples of the strobilurin compounds in the present invention include the followings:
kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxyacetamide (racemic or enantiomer, containing a mixture of R-enantiomer and S-enantiomer (optional ratio), hereinafter referred to as a compound 1).

Examples of the metalaxyl compounds include the followings:
metalaxyl and metalaxyl-M (also known as mefenoxam).

Examples of the SDHI compounds in the present invention include the followings:
sedaxane, penflufen, carboxin, boscalid, furametpyr, flutolanil, fluxapyroxad, isopyrazam, fluopyram, and thifluzamide.

Examples of the other fungicidal compounds in the present invention include the followings:
tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetami de, fludioxonil, ethaboxam, 3-chloro-5-phenyl-6-methyl-4-(2,6-difluorophenyl)pyridazine (hereinafter referred to as a compound 2), 3-cyano-5-phenyl-6-methyl-4-(2,6-difluorophenyl)pyridazine (hereinafter referred to as a compound 3), and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio), hereinafter referred to as a compound 4).

Examples of the plant growth regulators in the present invention include the followings:
ethephon, chlormequat-chloride, mepiquat-chloride, and 4-oxo-4-(2-phenylethyl)aminobutyric acid (hereinafter referred to as a compound 5).

In the present invention, the compounds of the group A used to treat seeds are publicly known compounds, and may be synthesized based on well known patent documents. Also, commercially available preparations or standard products may be purchased and used as the compounds of the group A.

In the step of treating soybean seeds, corn seeds, or cotton seeds with the compounds of the group A in the present invention, the compounds of the group A are usually mixed with a carrier such as a solid carrier or liquid carrier and further added with auxiliaries for preparations such as surfactants according to the need to be formulated into preparations. The dosage is preferably an aqueous suspension preparation.

As the compounds of the compound A used to treat crop seeds in the present invention, two or more preparations each constituted of a single component may be used in combination, or a preparation constituted of two or more components may be used.

The compounds of the above group A used for the above treatment are applied in an amount of usually 0.2 to 5000 g, and preferably 0.5 to 1000 g based on 100 kg of the seeds. Examples of a method for applying effective components to the seeds include a method in which the seeds are powder-coated with a preparation containing effective components; a method in which the seeds are dipped in a preparation containing effective components; a method in which a preparation containing effective components is sprayed on the seeds; and a method in which the seeds are coated with a carrier containing effective components.

The present invention includes the step of treating a field with at least one PPO-inhibiting compound before sowing or after sowing soybean seeds, corn seeds, or cotton seeds which are treated with the compounds of the group A.

The PPO-inhibiting compound in the present invention include flumioxazin, sulfentrazone, saflufenacil, oxyfluorfen and fomesafen-sodium.

These PPO-inhibiting compounds are all publicly known and thecommerciallyavailablepreparationsorthestandardproducts may be purchased and used.

In the step of treating a field with the PPO-inhibiting compound, the PPO-inhibiting compound is usually mixed with a carrier such as a solid carrier or liquid carrier and further added with auxiliaries for preparations such as surfactants according to the need to be formulated into preparations.

Examples of a method for applying the PPO-inhibiting compound to a field include a method in which the PPO-inhibiting compound is sprayed on field soil and a method in which the PPO-inhibiting compound is sprayed on weeds after the weeds germinate.

The amount of the PPO-inhibiting compound used in the step of applying the PPO-inhibiting compound to a field is usually 5 to 5000 g, preferably 10 to 1000 g, and more preferably 20 to 500 g per 10000 m². In this case, adjuvants may be added to the PPO-inhibiting compound to apply the PPO-inhibiting compound to the field.

In the present invention, the soybean seeds, corn seeds, or cotton seeds treated with the compounds of the group A are sowed in a field by a usual method. In the method of controlling pests according to the present invention, a field may be treated with the PPO-inhibiting compoundbefore sowing the soybean seeds, corn seeds, or cotton seeds, or at the same time or after sowing these seeds.

When a field is treated with the PPO-inhibiting compound before sowing the soybean seeds or corn seeds, the PPO-inhibiting compound is applied before 50 days to immediately before sowing, preferably before 30 days to immediately before sowing, more preferably before 20 days to immediately before sowing, and even more preferably before 10 days to immediately before sowing.

When a field is treated with the PPO-inhibiting compound after sowing the soybean seeds or corn seeds, the PPO-inhibiting compound is preferably applied immediately after to 50 days after sowing, and more preferably immediately after to 3 days after sowing. Examples of a specific treatment term when a field is treated with the PPO-inhibiting compound after sowing the soybean seeds include a term before germination to anthesis of the soybean. Among before germination to anthesis of the soybean, preferred is before germination to a term of 6 compound leaves of the soybean, further preferred is before germination to a term of 3 compound leaves of the soybean. A specific treating term when a field is treated with the PPO-inhibiting compound after sowing the corn seeds is before germination to a 12 leaves term, preferably before germination to a 8 leaves term, further preferably before germination to a 6 leaves term. In addition, a leaf age of corn is determined by the Leaf Collar Method.

When a field is treated with the PPO-inhibiting compound before sowing the cotton seeds, the PPO-inhibiting compound is applied before 50 days to immediately before sowing, preferably before 30 days to immediately before sowing, and more preferably before 20 days to immediately before sowing.

When a field is treated with the PPO-inhibiting compound after sowing the cotton seeds, the PPO-inhibiting compound is preferably applied immediately after to 70 days after sowing, and more preferably 30 days after to 50 days after sowing. Examples of a specific treating term when a field is treated with the PPO-inhibiting compound after sowing the cotton seeds include before germination to anthesis of the cotton. Preferred is a lignification initiation term of the stem base of the cotton to a term when a lignification portion is 20 cm from the base.

The method of controlling pests according to the present invention ensures that harmful arthropods, noxious nematodes and/or plant pathogens, andpests such as weeds in soybean fields, corn fields, or cotton fields can be controlled.

As harmful arthropods, the following examples are given.

Noxious insects belonging to order Hemiptera: Delphacidae such as Laodelphax striatellus, Nilaparvata lugens, and Sogatella furcifera, Deltocephalidae such as Nephotettix cincticeps and Nephotettix virescens, Aphididae such as Aphis gossypii, Myzus persicae, Brevicoryne brassicae, Macrosiphum euphorbiae, Aulacorthum solani, Rhopalosiphum padi, and Toxoptera citricidus, Pentatomidae such as Nezara antennata, Riptortus clavetus, Leptocorisa chinensis, Eysarcoris parvus, Halyomorpha mista, and Lygus lineolaris, Aleyrodidae such as Trialeurodes vaporariorum, Bemisia tabaci, and Bemisia argentifolii, Coccidae such as Aonidiella aurantii, Comstockaspis perniciosa, Unaspis citri, Ceroplastes rubens, and Icerya purchase, Tingidae, and Psyllidae;
noxious insects belonging to order Lepidoptera: Pyralidae such as Chilo suppressalis, Tryporyza incertulas, Cnaphalocrocis medinalis, Notarcha derogate, Plodia interpunctella, Ostrinia furnacalis, Ostrinia nubilaris, Hellula undalis, and Pediasia teterrellus, Noctuidae such as Spodoptera litura, Spodoptera exigua, Pseudaletia separate, Mamestra brassicae, Agrotis ipsilon, Plusia nigrisigna, Trichoplusia spp., Heliothis spp., and Helicoverpa spp., Pieridae such as Pieris rapae, Tortricidae such as Adoxophyes spp., Grapholita molesta, Leguminivora glycinivorella, Matsumuraeses azukivora, Adoxophyesorana fasciata, Adoxophyes sp., Homona magnanima, Archips fuscocupreanus, and Cydia pomonella, Gracillariidae such as Caloptilia theivora and Phyllonorycter ringoneella, Carposinidae such as Carposina niponensis, Lyonetiidae such as Lyonetia spp., Lymantriidae such as Lymantriidae spp. and Euproctis spp., Yponameutidae such as Plutella xylostella, Gelechiidae such as Pectinophora gossypiella and Phthorimaea operculella, Arctiidae such as Hyphantria cunea, and Tineidae such as Tinea translucens and Tineola bisselliella;
noxious insects belonging to order Thripidae: Thysanoptera such as Frankliniella occidentalis, Thrips parmi, Scirtothrips dorsalis, Thrips tabaci, Frankliniella intonsa, and Frankliniella fusca;
noxious insects belonging to order Diptera: Agromyzidae such as Musca domestica, Culexpopiens pallens, Tabanus trigonus, Hylemya antique, Hylemya platura, Anopheles sinensis, Agromyza oryzae, Hydrellia griseola, Chlorops oryzae, and Liriomyza trifolii, Dacus cucurbitae, and Ceratitis capitata;
noxious insects belonging to order Coleoptera: Epilachna vigintioctopunctata, Aulacophora femoralis, Phyllotreta striolata, Oulema oryzae, Echinocnemus squameus, Lissorhoptrus oryzophilus, Anthonomus grandis, Callosobruchus chinensis, Sphenophorus venatus, Popillia japonica, Anomala cuprea, Diabrotica spp., Leptinotarsa decemlineata, Agriotes spp., Lasioderma serricorne, Anthrenus verbasci, Tribolium castaneum, Lyctus brunneus, Anoplophora malasiaca, and Tomicus piniperda;
noxious insects belonging to order Orthoptera: Locusta migratoria, Gryllotalpa africana, Oxya yezoensis, and Oxya japonica;
noxious insects belonging to order Hymenoptera: Athalia rosae, Acromyrmex spp., and Solenopsis spp.;
noxious insects belonging to order Blattidae: Blattella germanica, Periplaneta fuliginosa, Periplaneta americana, Periplaneta brunnea, and Blatta orientalis; and
noxious insects belonging to order Acarina: Tetranychidae such as Tetranychus urticae, Panonychus citri, and Oligonychus spp., Eriophyidae such as Aculops pelekassi, Tarsonemidae such as Polyphagotarsonemus latus, Tenuipalpidae, Tuckerellidae, Acaridae such as Tyrophagus putrescentiae, Dermanyssidae such as Dermatophagoides farina and Dermatophagoides ptrenyssnus, and Cheyletidae such as Cheyletus eruditus, Cheyletus malaccensis, and Cheyletus moorei.

As the plant pathogens, the following examples can be given.

Cercospora gossypina, Cercospora kikuchii, Cercospora zeae-maydis, Cercospora sojina, Phakopsora gossypii, Rhizoctonia solani, Colletotrichum gossypii, Peronospora gossypina, Aspergillus spp., Penicillium spp., Fusarium spp., Tricoderma spp., Thielaviopsis spp., Rhizopus spp., Mucor spp., Corticium spp., Phoma spp., Diplodia spp., Verticillium spp., Puccinia spp., Mycosphaerella spp., Phytophthora spp. (for example, Phytophthora sojae, Phytophthora nicotianae var. nicotianae, Phytophthora infestans, and Phytophthora erythroseptica), Pythium spp. (for example, Pythium debaryanum, Pythium sylvaticum, Pythium graminicola, Pythium irregular, and Pythium ultimum), Microsphaera diffusa, Diaporthe phaseolorum var. sojae, Septoria glycines, Phakopsora pachyrhizi, Sclerotinia sclerotiorum, Elsinoe glycines, Ustilago maydis, Cochliobolus heterostrophus, Gloeocercospora sorghi, and Alternaria spp.

As the weeds, the following examples are given.

Weeds of the family Urticaceae: Urtica urens;
weeds of the family Polygonaceae: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicas, Rumex crispus, Rumex obtusifolius, and Rumex acetosa;
weeds of the family Portulacaceae: Portulaca oleracea;
weeds of the family Caryophyllaceae: Stellaria media, Cerastium holosteoides, Cerastium glomeratum, Spergula arvensis, and Silene gallica;
weeds of the family Molluginaceae: Mollugo verticillata;
weeds of the family Chenopodiaceae: Chenopodium album, Chenopodium ambrosioides, Kochia scoparia, Salsola kali, and Atriplex spp.;
weeds of the family Amaranthaceae: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, and Alternanthera tenella;
weeds of the family Papaveraceae: Papaver rhoeas and Argemone mexicana;
weeds of the family Brassicaceae: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspiarvense, Myagrum rugosum, Lepidium virginicum, and Coronopus didymus;
weeds of the family Capparaceae: Cleome affinis;
weeds of the family Fabaceae: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsute, Indigofera truxillensis, and Vigna sinensis;
weeds of the family Oxalidaceae: Oxalis corniculata, Oxalis strica, and Oxalis oxyptera;
weeds of the family Geraniaceae: Geranium carolinense and Erodium cicutarium;
weeds of the family Euphorbiaceae: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, and Ricinus communis;
weeds of the family Malvaceae: Abutilon theophrasti, Sida rhombiforia, Sida cordifolia, Sida spinosa, Sida glaziovii, Sida santaremnensis, Hibiscus trionum, Anoda cristata, and Malvastrum coromandelianum;
weeds of the family Sterculiaceae: Waltheria indica;
weeds of the family Violaceae: Viola arvensis, and Viola tricolor;
weeds of the family Cucurbitaceae: Sicyos angulatus, Echinocystis lobata, and Momordica charantia;
weeds of the family Lythraceae: Lythrum salicaria;
weeds of the family Apiaceae: Hydrocotyle sibthorpioides;
weeds of the family Sapindaceae: Cardiospermum halicacabum;
weeds of the family Primulaceae: Anagallis arvensis;
weeds of the family Asclepiadaceae: Asclepias syriaca and Ampelamus albidus;
weeds of the family Rubiaceae: Galium aparine, Galium spurium var. echinospermon, Spermacoce latifolia, Richardia brasiliensis, and Borreria alata;
weeds of the family Convolvulaceae: Ipomoea nil, Ipomoea hederacea, Ipomoea purpurea, Ipomoea hederacea var. integriuscula, Ipomoea lacunose, Ipomoea triloba, Ipomoea acuminate, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoids, and Jacquemontia tamnifolia;
weeds of the family Boraginaceae: Myosotis arvensis;
weeds of the family Lamiaceae: Lamium purpureum, Lamium amplexicaule, Leonotis nepetaefolia, Hyptis suaveolens, Hyptis lophanta, Leonurus sibiricus, and Stachys arvensis;
weeds of the family Solanaceae: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, and Nicandra physaloides;
weeds of the family Scrophulariaceae: Veronica hederaefolia, Veronica persica, and Veronica arvensis;
weeds of the family Plantaginaceae: Plantago asiatica;
weeds of the family Asteraceae: Xanthium pensylvanicum, Xanthium occidentale, Helianthusannuus, Matricaria chamomilla, Matricaria perforate, Chrysanthemum segetum, Matricaria matricarioides, Artemisia princeps, Artemisia vulgaris, Artemisia verlotorum, Solidago altissima, Taraxacum officinale, Galinsoga ciliate, Galinsoga parviflora, Senecio vulgaris, Senecio brasiliensis, Senecio grisebachii, Conyza bonariensis, Conyza Canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, and Soliva sessilis;
weeds of the family Liliaceae: Allium canadense and Allium vineale;
weeds of the family Commelinaceae: Commelina communis, Commelina bengharensis, and Commelina erecta;
weeds of the family Poaceae: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, and Rottboellia cochinchinensis;
weeds of the family Cyperaceae: Cyperus microiria, Cyperus iria, Cyperus odoratus, Cyperus rotundus, Cyperus esculentus, and Kyllinga gracillima; and
weeds of the family Equisetaceae: Equisetum arvense and Equisetum palustre.

In the method of controlling pests of the present invention, one or more other agrochemicals may be used in combination with the compounds of the group A or the PPO-inhibiting compound either simultaneously or separately. Examples of the other agrochemicals include insecticides, acaricides, nematicides, fungicides, herbicides, plant growth regulators, and safeners.

As the above herbicides, plant growth regulators, and safeners, the following examples are given.

Herbicides: dicamba and a salt thereof (diglycolamine salt, dimethylammonium salt, isopropylammonium salt, potassium salt, sodium salt and choline salt), 2,4-D and a salt or ester thereof (butotyl ester, dimethylammonium salt, diolamine salt, ethylhexyl ester, isooctyl ester, isopropylammonium salt, sodium salt and triisopropanolamine salt), 2,4-DB and a salt or ester thereof (dimethylammonium salt, isooctyl ester and choline salt), MCPA and a salt or ester thereof (dimethylammonium salt, 2-ethylhexylester, isooctyl ester, sodium salt and choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, tololamine salt and choline salt), mecoprop-P and a salt or ester thereof (dimethylammonium salt, 2-ethylhexyl ester, isobutyl salt, potassium salt and choline salt), dichlorprop and a salt or ester thereof (butotyl ester, dimethylammonium salt, 2-ethylhexyl ester, isooctyl ester, methyl ester, potassium salt, sodium salt and choline salt), dichlorprop-P, dichlorprop-P dimethylammonium, bromoxynil, bromoxynil-octanoate, dichlobenil, metiozolin, ioxynil, ioxynil-octanoate, di-allate, butylate, tri-allate, phenmedipham, chlorpropham, asulam, phenisopham, benthiocarb, molinate, esprocarb, pyributicarb, prosulfocarb, orbencarb, EPTC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminocyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, triafamone, fentrazamide, dimethenamid, dimethenamid-P, ACN, bennzobicyclon, dithiopyr, triclopyr and a salt or ester thereof (butotyl ester and triethylammonium salt), fluroxypyr, fluroxypyr-meptyl, thiazopyr, aminopyralid and a salt thereof (potassium salt, triisopanolammonium salt and choline salt), clopyralid and a salt thereof (olamine salt, potassium salt, triethylammonium salt and choline salt), picloram and a salt thereof (potassium salt, triisopanolammonium salt and choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, bicyclopyrone, mesotrione, sulcotrione, tefuryltrione, tembotrione, isoxachlortole, isoxaflutole, benzofenap, pyrasulfotole, pyrazolynate, pyrazoxyfen, topramezone, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, fenoxasulfone, glyphosate, glyphosate-isopropylamine, glyphosate-trimethylsulfonium, glyphosate-ammonium, glyphosate-diammonium, glyphosate-sodium, glyphosate-potassium, glyphosate-guanidine, glufosinate, glufosinate-ammonium, glufosinate-P, glufosinate-P-sodium, bialafos, anilofos, bensulide, butamifos, paraquat, paraquat-dichloride, diquat, and diquat-dibromide.

Plant growth regulators: hymexazol, paclobutrazol, uniconazole, uniconazole-P, inabenfide, prohexadione-calcium, 1-methylcyclopropene, trinexapac-ethyl, and gibberellins.

Safeners: benoxacor, cloquintocet, cloquintocet-mexyl, cyometrinil, cyprosulfamide, dichlormid, dicyclonon, dietholate, fenchlorazole, fenchlorazole-ethyl, fenclorim, flurazole, fluxofenim, furilazole, isoxadifen, isoxadifen-ethyl, mefenpyr, mefenpyr-diethyl, mephenate, naphthalic anhydride, and oxabetrinil.

In the present invention, chlorimuron-ethyl, cloransulam-methyl, pyroxasulfone, imazethapyr-ammonium, metribuzin, 2,4-D, dicamba, mesotrione, tembotrione and isoxaflutole are particularly preferable as the herbicides which may be simultaneously used in combination with the PPO-inhibiting compound.

In the present invention, cyprosulfamide, mefenpyr-diethyl, and isoxadifen-ethyl are particularly preferable as the safener which may be simultaneously used in combination with the PPO-inhibiting compound.

The followings are more preferable as the combinations of the herbicide and/or safener which may be used in combination with the PPO-inhibiting compound:
a combination of flumioxazin and chlorimuron-ethyl;
a combination of flumioxazin and cloransulam-methyl;
a combination of flumioxazin, chlorimuron-ethyl, and pyroxasulfone;
a combination of flumioxazin and pyroxasulfone;
a combination of flumioxazin and imazethapyr-ammonium;
a combination of flumioxazin and metribuzin;

a combination of flumioxazin and 2,4-D;
a combination of flumioxazin and dicamba;
a combination of flumioxazin and mesotrione;
a combination of flumioxazin and tembotrione;
a combination of flumioxazin and isoxaflutole;
a combination of flumioxazin, dicamba, and isoxadifen-ethyl;
a combination of flumioxazin, isoxaflutole, and cyprosulfamide; and
a combination of flumioxazin, tembotrione, and isoxadifen.

### EXAMPLES

Hereinbelow, the present invention will be described in detail byway of examples, but the present invention is not limited to these examples.

First, given are the standard of evaluation of pest control effect (harmful arthropod control effect, plant pathogen control effect, herbicidal effect), and that of crop phytotoxicity, which will be shown in examples hereinafter.

[Harmful Arthropod Control Effect]

In the evaluation of the harmful arthropod control effect, each insect at the time of investigation is examined by discriminating whether the insect is alive or dead to calculate a controlling value by the following equation.

Controlling value(%)=100×(1−T/C)
where C represents the number of insects to be observed in an untreated area, and
T represents the number of insects to be observed in a treated area

[Plant Pathogen Control Effect]

In the evaluation of the plant pathogen control effect, the symptom of each test plant in a treated area is compared with that in an untreated area and when there is no or almost no difference in symptom between the treated area and the untreated area at the time of investigation, the case is given “0”, and when no or almost no change in symptom caused by plant pathogens is observed at the time of investigation, the case is given “100”, thereby grading each sample between 0 to 100.

[Herbicidal Effect and Crop Phytotoxicity]

In the evaluation of the herbicidal effect, the germination or growth condition of each test weed in a treated area is compared with that in an untreated area and when there is no or almost no difference in germination or growth condition between the treated area and the untreated area at the time of investigation, the case is given “0”, and when the test plant perfectly withers and dies, or the germination or growth of the plant is perfectly restricted at the time of investigation, the case is given “100”, thereby grading each sample between 0 to 100.

In the evaluation of crop phytotoxicity, the case where almost no crop injury is observed is expressed as “harmless”, the case where mild crop phytotoxicity are observed is expressed as “small”, the case where moderate crop phytotoxicity are observed is expressed as “middle”, and the case where severe crop phytotoxicity are observed is expressed as “large”.

In the step of treating seeds with two or more compounds selected from the compound group A including specific insecticidal compounds, nematicidal compounds, fungicidal compounds, and plant growth regulators, the seeds are treated with a combination selected from the combinations shown in Tables 1, 2 and 3 to thereby confirm the control effect, and crop phytotoxicity based on the above standards according to the following methods.

TABLE 1

| | |
|---|---|
| Number of | |
| combination | Combinations of compounds |

| | | |
|---|---|---|
| 1-1 | Clothianidin | Ipconazole |
| 1-2 | Clothianidin | Metconazole |
| 1-3 | Clothianidin | Diphenoconazole |
| 1-4 | Clothianidin | Tebuconazole |
| 1-5 | Clothianidin | Prothioconazole |
| 1-6 | Clothianidin | Fluquinconazole |
| 1-7 | Clothianidin | Triticonazole |
| 1-8 | Clothianidin | Imazalil |
| 1-9 | Clothianidin | Pencycuron |
| 1-10 | Clothianidin | Prochloraz |
| 1-11 | Clothianidin | Pyraclostrobin |
| 1-12 | Clothianidin | Azoxystrobin |
| 1-13 | Clothianidin | Trifloxystrobin |
| 1-14 | Clothianidin | Metalaxyl |
| 1-15 | Clothianidin | Metalaxyl-M |
| 1-16 | Clothianidin | Fludioxonil |
| 1-17 | Clothianidin | Thiram |
| 1-18 | Clothianidin | Mancozeb |
| 1-19 | Clothianidin | Flutolanil |
| 1-20 | Clothianidin | Sedaxane |
| 1-21 | Clothianidin | Penflufen |
| 1-22 | Clothianidin | Fluxapyroxad |
| 1-23 | Clothianidin | Bacillus firmus |
| 1-24 | Clothianidin | Pasteuria penetrans |
| 1-25 | Clothianidin | Abamectin |
| 1-26 | Clothianidin | Thiodicarb |
| 1-27 | Clothianidin | Tolclophos-methyl |
| 1-28 | Clothianidin | Ethaboxam |
| 1-29 | Clothianidin | Compound 4 |
| 1-30 | Clothianidin | Compound 2 |
| 1-31 | Clothianidin | Compound 3 |
| 1-32 | Clothianidin | Compound 1 |
| 1-33 | Clothianidin | Compound 5 |
| 1-34 | Clothianidin | Orysastrobin |
| 1-35 | Clothianidin | Isotianil |
| 1-36 | Clothianidin | Probenazole |
| 1-37 | Clothianidin | Diclocymet |
| 1-38 | Clothianidin | Furametpyr |
| 1-39 | Imidacloprid | Ipconazole |
| 1-40 | Imidacloprid | Metconazole |
| 1-41 | Imidacloprid | Diphenoconazole |
| 1-42 | Imidacloprid | Tebuconazole |
| 1-43 | Imidacloprid | Prothioconazole |
| 1-44 | Imidacloprid | Fluquinconazole |
| 1-45 | Imidacloprid | Triticonazole |
| 1-46 | Imidacloprid | Imazalil |
| 1-47 | Imidacloprid | Pencycuron |
| 1-48 | Imidacloprid | Prochloraz |
| 1-49 | Imidacloprid | Pyraclostrobin |
| 1-50 | Imidacloprid | Azoxystrobin |
| 1-51 | Imidacloprid | Trifloxystrobin |
| 1-52 | Imidacloprid | Metalaxyl |
| 1-53 | Imidacloprid | Metalaxyl-M |
| 1-54 | Imidacloprid | Fludioxonil |
| 1-55 | Imidacloprid | Thiram |
| 1-56 | Imidacloprid | Mancozeb |
| 1-57 | Imidacloprid | Flutolanil |
| 1-58 | Imidacloprid | Sedaxane |
| 1-59 | Imidacloprid | Penflufen |
| 1-60 | Imidacloprid | Fluxapyroxad |
| 1-61 | Imidacloprid | Bacillus firmus |
| 1-62 | Imidacloprid | Pasteuria penetrans |
| 1-63 | Imidacloprid | Abamectin |
| 1-64 | Imidacloprid | Thiodicarb |
| 1-65 | Imidacloprid | Tolclophos-methyl |
| 1-66 | Imidacloprid | Ethaboxam |
| 1-67 | Imidacloprid | Compound 4 |
| 1-68 | Imidacloprid | Compound 2 |
| 1-69 | Imidacloprid | Compound 3 |
| 1-70 | Imidacloprid | Compound 1 |
| 1-71 | Imidacloprid | Compound 5 |
| 1-72 | Imidacloprid | Orysastrobin |
| 1-73 | Imidacloprid | Isotianil |
| 1-74 | Imidacloprid | Probenazole |
| 1-75 | Imidacloprid | Diclocymet |
| 1-76 | Imidacloprid | Furametpyr |
| 1-77 | Thiamethoxam | Ipconazole |
| 1-78 | Thiamethoxam | Metconazole |
| 1-79 | Thiamethoxam | Diphenoconazole |
| 1-80 | Thiamethoxam | Tebuconazole |
| 1-81 | Thiamethoxam | Prothioconazole |
| 1-82 | Thiamethoxam | Fluquinconazole |
| 1-83 | Thiamethoxam | Triticonazole |
| 1-84 | Thiamethoxam | Imazalil |
| 1-85 | Thiamethoxam | Pencycuron |
| 1-86 | Thiamethoxam | Prochloraz |
| 1-87 | Thiamethoxam | Pyraclostrobin |
| 1-88 | Thiamethoxam | Azoxystrobin |
| 1-89 | Thiamethoxam | Trifloxystrobin |
| 1-90 | Thiamethoxam | Metalaxyl |
| 1-91 | Thiamethoxam | Metalaxyl-M |
| 1-92 | Thiamethoxam | Fludioxonil |
| 1-93 | Thiamethoxam | Thiram |
| 1-94 | Thiamethoxam | Mancozeb |
| 1-95 | Thiamethoxam | Flutolanil |
| 1-96 | Thiamethoxam | Sedaxane |
| 1-97 | Thiamethoxam | Penflufen |
| 1-98 | Thiamethoxam | Fluxapyroxad |
| 1-99 | Thiamethoxam | Bacillus firmus |
| 1-100 | Thiamethoxam | Pasteuria penetrans |
| 1-101 | Thiamethoxam | Abamectin |
| 1-102 | Thiamethoxam | Thiodicarb |
| 1-103 | Thiamethoxam | Tolclophos-methyl |
| 1-104 | Thiamethoxam | Ethaboxam |
| 1-105 | Thiamethoxam | Compound 4 |
| 1-106 | Thiamethoxam | Compound 2 |
| 1-107 | Thiamethoxam | Compound 3 |
| 1-108 | Thiamethoxam | Compound 1 |
| 1-109 | Thiamethoxam | Compound 5 |
| 1-110 | Thiamethoxam | Orysastrobin |
| 1-111 | Thiamethoxam | Isotianil |
| 1-112 | Thiamethoxam | Probenazole |
| 1-113 | Thiamethoxam | Diclocymet |
| 1-114 | Thiamethoxam | Furametpyr |
| 1-115 | Beta-cyfluthrin | Ipconazole |
| 1-116 | Beta-cyfluthrin | Metconazole |
| 1-117 | Beta-cyfluthrin | Diphenoconazole |
| 1-118 | Beta-cyfluthrin | Tebuconazole |
| 1-119 | Beta-cyfluthrin | Prothioconazole |
| 1-120 | Beta-cyfluthrin | Fluquinconazole |
| 1-121 | Beta-cyfluthrin | Triticonazole |
| 1-122 | Beta-cyfluthrin | Imazalil |
| 1-123 | Beta-cyfluthrin | Pencycuron |
| 1-124 | Beta-cyfluthrin | Prochloraz |
| 1-125 | Beta-cyfluthrin | Pyraclostrobin |
| 1-126 | Beta-cyfluthrin | Azoxystrobin |
| 1-127 | Beta-cyfluthrin | Trifloxystrobin |
| 1-128 | Beta-cyfluthrin | Metalaxyl |
| 1-129 | Beta-cyfluthrin | Metalaxyl-M |
| 1-130 | Beta-cyfluthrin | Fludioxonil |
| 1-131 | Beta-cyfluthrin | Thiram |
| 1-132 | Beta-cyfluthrin | Mancozeb |
| 1-133 | Beta-cyfluthrin | Flutolanil |
| 1-134 | Beta-cyfluthrin | Sedaxane |
| 1-135 | Beta-cyfluthrin | Penflufen |
| 1-136 | Beta-cyfluthrin | Fluxapyroxad |
| 1-137 | Beta-cyfluthrin | Bacillus firmus |
| 1-138 | Beta-cyfluthrin | Pasteuria penetrans |
| 1-139 | Beta-cyfluthrin | Abamectin |
| 1-140 | Beta-cyfluthrin | Thiodicarb |
| 1-141 | Beta-cyfluthrin | Tolclophos-methyl |
| 1-142 | Beta-cyfluthrin | Ethaboxam |
| 1-143 | Beta-cyfluthrin | Compound 4 |
| 1-144 | Beta-cyfluthrin | Compound 2 |
| 1-145 | Beta-cyfluthrin | Compound 3 |
| 1-146 | Beta-cyfluthrin | Compound 1 |
| 1-147 | Beta-cyfluthrin | Compound 5 |
| 1-148 | Abamectin | Ipconazole |
| 1-149 | Abamectin | Metconazole |
| 1-150 | Abamectin | Diphenoconazole |
| 1-151 | Abamectin | Tebuconazole |
| 1-152 | Abamectin | Prothioconazole |
| 1-153 | Abamectin | Fluquinconazole |
| 1-154 | Abamectin | Triticonazole |
| 1-155 | Abamectin | Imazalil |
| 1-156 | Abamectin | Pencycuron |
| 1-157 | Abamectin | Prochloraz |
| 1-158 | Abamectin | Pyraclostrobin |
| 1-159 | Abamectin | Azoxystrobin |
| 1-160 | Abamectin | Trifloxystrobin |
| 1-161 | Abamectin | Metalaxyl |
| 1-162 | Abamectin | Metalaxyl-M |
| 1-163 | Abamectin | Fludioxonil |
| 1-164 | Abamectin | Thiram |
| 1-165 | Abamectin | Mancozeb |
| 1-166 | Abamectin | Flutolanil |
| 1-167 | Abamectin | Sedaxane |
| 1-168 | Abamectin | Penflufen |
| 1-169 | Abamectin | Fluxapyroxad |
| 1-170 | Abamectin | Bacillus firmus |
| 1-171 | Abamectin | Pasteuria penetrans |
| 1-172 | Abamectin | Thiodicarb |
| 1-173 | Abamectin | Tolclophos-methyl |
| 1-174 | Abamectin | Ethaboxam |
| 1-175 | Abamectin | Compound 4 |
| 1-176 | Abamectin | Compound 2 |
| 1-177 | Abamectin | Compound 3 |
| 1-178 | Abamectin | Compound 1 |
| 1-179 | Abamectin | Compound 5 |
| 1-180 | Thiodicarb | Ipconazole |
| 1-181 | Thiodicarb | Metconazole |
| 1-182 | Thiodicarb | Diphenoconazole |
| 1-183 | Thiodicarb | Tebuconazole |
| 1-184 | Thiodicarb | Prothioconazole |
| 1-185 | Thiodicarb | Fluquinconazole |
| 1-186 | Thiodicarb | Triticonazole |
| 1-187 | Thiodicarb | Imazalil |
| 1-188 | Thiodicarb | Pencycuron |
| 1-189 | Thiodicarb | Prochloraz |
| 1-190 | Thiodicarb | Pyraclostrobin |
| 1-191 | Thiodicarb | Azoxystrobin |
| 1-192 | Thiodicarb | Trifloxystrobin |
| 1-193 | Thiodicarb | Metalaxyl |
| 1-194 | Thiodicarb | Metalaxyl-M |
| 1-195 | Thiodicarb | Fludioxonil |
| 1-196 | Thiodicarb | Thiram |
| 1-197 | Thiodicarb | Mancozeb |
| 1-198 | Thiodicarb | Flutolanil |
| 1-199 | Thiodicarb | Sedaxane |
| 1-200 | Thiodicarb | Penflufen |
| 1-201 | Thiodicarb | Fluxapyroxad |
| 1-202 | Thiodicarb | Bacillus firmus |
| 1-203 | Thiodicarb | Pasteuria penetrans |
| 1-204 | Thiodicarb | Tolclophos-methyl |
| 1-205 | Thiodicarb | Ethaboxam |
| 1-206 | Thiodicarb | Compound 4 |
| 1-207 | Thiodicarb | Compound 2 |
| 1-208 | Thiodicarb | Compound 3 |
| 1-209 | Thiodicarb | Compound 1 |
| 1-210 | Thiodicarb | Compound 5 |
| 1-211 | Thiodicarb | Furametpyr |
| 1-212 | Metalaxyl | Ipconazole |
| 1-213 | Metalaxyl | Metconazole |
| 1-214 | Metalaxyl | Diphenoconazole |
| 1-215 | Metalaxyl | Tebuconazole |
| 1-216 | Metalaxyl | Prothioconazole |
| 1-217 | Metalaxyl | Fluquinconazole |
| 1-218 | Metalaxyl | Triticonazole |
| 1-219 | Metalaxyl | Imazalil |
| 1-220 | Metalaxyl | Pencycuron |
| 1-221 | Metalaxyl | Prochloraz |
| 1-222 | Metalaxyl | Pyraclostrobin |
| 1-223 | Metalaxyl | Azoxystrobin |
| 1-224 | Metalaxyl | Trifloxystrobin |
| 1-225 | Metalaxyl | Fludioxonil |
| 1-226 | Metalaxyl | Thiram |
| 1-227 | Metalaxyl | Flutolanil |
| 1-228 | Metalaxyl | Sedaxane |
| 1-229 | Metalaxyl | Penflufen |
| 1-230 | Metalaxyl | Fluxapyroxad |
| 1-231 | Metalaxyl | Bacillus firmus |
| 1-232 | Metalaxyl | Pasteuria penetrans |
| 1-233 | Metalaxyl | Tolclophos-methyl |
| 1-234 | Metalaxyl | Ethaboxam |
| 1-235 | Metalaxyl | Compound 4 |
| 1-236 | Metalaxyl | Compound 2 |
| 1-237 | Metalaxyl | Compound 3 |
| 1-238 | Metalaxyl | Compound 1 |
| 1-239 | Metalaxyl | Compound 5 |
| 1-240 | Metalaxyl | Furametpyr |
| 1-241 | Metalaxyl-M | Ipconazole |
| 1-242 | Metalaxyl-M | Metconazole |
| 1-243 | Metalaxyl-M | Diphenoconazole |
| 1-244 | Metalaxyl-M | Tebuconazole |
| 1-245 | Metalaxyl-M | Prothioconazole |
| 1-246 | Metalaxyl-M | Fluquinconazole |
| 1-247 | Metalaxyl-M | Triticonazole |
| 1-248 | Metalaxyl-M | Imazalil |
| 1-249 | Metalaxyl-M | Pencycuron |
| 1-250 | Metalaxyl-M | Prochloraz |
| 1-251 | Metalaxyl-M | Pyraclostrobin |
| 1-252 | Metalaxyl-M | Azoxystrobin |
| 1-253 | Metalaxyl-M | Trifloxystrobin |
| 1-254 | Metalaxyl-M | Fludioxonil |
| 1-255 | Metalaxyl-M | Thiram |
| 1-256 | Metalaxyl-M | Flutolanil |
| 1-257 | Metalaxyl-M | Sedaxane |
| 1-258 | Metalaxyl-M | Penflufen |
| 1-259 | Metalaxyl-M | Fluxapyroxad |
| 1-260 | Metalaxyl-M | Bacillus firmus |
| 1-261 | Metalaxyl-M | Pasteuria penetrans |
| 1-262 | Metalaxyl-M | Tolclophos-methyl |
| 1-263 | Metalaxyl-M | Ethaboxam |
| 1-264 | Metalaxyl-M | Compound 4 |
| 1-265 | Metalaxyl-M | Compound 2 |
| 1-266 | Metalaxyl-M | Compound 3 |
| 1-267 | Metalaxyl-M | Compound 1 |
| 1-268 | Metalaxyl-M | Compound 5 |
| 1-269 | Metalaxyl-M | Furametpyr |
| 1-270 | Fludioxonil | Ipconazole |
| 1-271 | Fludioxonil | Metconazole |
| 1-272 | Fludioxonil | Diphenoconazole |
| 1-273 | Fludioxonil | Tebuconazole |
| 1-274 | Fludioxonil | Prothioconazole |
| 1-275 | Fludioxonil | Fluquinconazole |
| 1-276 | Fludioxonil | Triticonazole |
| 1-277 | Fludioxonil | Imazalil |
| 1-278 | Fludioxonil | Pencycuron |
| 1-279 | Fludioxonil | Prochloraz |
| 1-280 | Fludioxonil | Pyraclostrobin |
| 1-281 | Fludioxonil | Azoxystrobin |
| 1-282 | Fludioxonil | Trifloxystrobin |
| 1-283 | Fludioxonil | Thiram |
| 1-284 | Fludioxonil | Flutolanil |
| 1-285 | Fludioxonil | Sedaxane |
| 1-286 | Fludioxonil | Penflufen |
| 1-287 | Fludioxonil | Fluxapyroxad |
| 1-288 | Fludioxonil | Bacillus firmus |
| 1-289 | Fludioxonil | Pasteuria penetrans |
| 1-290 | Fludioxonil | Tolclophos-methyl |
| 1-291 | Fludioxonil | Ethaboxam |
| 1-292 | Fludioxonil | Compound 4 |
| 1-293 | Fludioxonil | Compound 2 |
| 1-294 | Fludioxonil | Compound 3 |
| 1-295 | Fludioxonil | Compound 1 |
| 1-296 | Fludioxonil | Compound 5 |
| 1-297 | Fludioxonil | Furametpyr |
| 1-298 | Ipconazole | Pyraclostrobin |
| 1-299 | Ipconazole | Azoxystrobin |
| 1-300 | Ipconazole | Trifloxystrobin |
| 1-301 | Ipconazole | Thiram |
| 1-302 | Ipconazole | Flutolanil |
| 1-303 | Ipconazole | Sedaxane |
| 1-304 | Ipconazole | Penflufen |
| 1-305 | Ipconazole | Fluxapyroxad |
| 1-306 | Ipconazole | Bacillus firmus |
| 1-307 | Ipconazole | Pasteuria penetrans |
| 1-308 | Ipconazole | Tolclophos-methyl |
| 1-309 | Ipconazole | Ethaboxam |
| 1-310 | Ipconazole | Compound 4 |
| 1-311 | Ipconazole | Compound 2 |
| 1-312 | Ipconazole | Compound 3 |
| 1-313 | Ipconazole | Compound 1 |
| 1-314 | Ipconazole | Compound 5 |
| 1-315 | Metconazole | Pyraclostrobin |
| 1-316 | Metconazole | Azoxystrobin |
| 1-317 | Metconazole | Trifloxystrobin |
| 1-318 | Metconazole | Thiram |
| 1-319 | Metconazole | Flutolanil |
| 1-320 | Metconazole | Sedaxane |
| 1-321 | Metconazole | Penflufen |
| 1-322 | Metconazole | Fluxapyroxad |
| 1-323 | Metconazole | Bacillus firmus |
| 1-324 | Metconazole | Pasteuria penetrans |
| 1-325 | Metconazole | Tolclophos-methyl |
| 1-326 | Metconazole | Ethaboxam |
| 1-327 | Metconazole | Compound 4 |
| 1-328 | Metconazole | Compound 2 |
| 1-329 | Metconazole | Compound 3 |
| 1-330 | Metconazole | Compound 1 |
| 1-331 | Metconazole | Compound 5 |
| 1-332 | Diphenoconazole | Pyraclostrobin |
| 1-333 | Diphenoconazole | Azoxystrobin |
| 1-334 | Diphenoconazole | Trifloxystrobin |
| 1-335 | Diphenoconazole | Thiram |
| 1-336 | Diphenoconazole | Flutolanil |
| 1-337 | Diphenoconazole | Sedaxane |
| 1-338 | Diphenoconazole | Penflufen |
| 1-339 | Diphenoconazole | Fluxapyroxad |
| 1-340 | Diphenoconazole | Bacillus firmus |
| 1-341 | Diphenoconazole | Pasteuria penetrans |
| 1-342 | Diphenoconazole | Tolclophos-methyl |
| 1-343 | Diphenoconazole | Ethaboxam |
| 1-344 | Diphenoconazole | Compound 4 |
| 1-345 | Diphenoconazole | Compound 2 |
| 1-346 | Diphenoconazole | Compound 3 |
| 1-347 | Diphenoconazole | Compound 1 |
| 1-348 | Diphenoconazole | Compound 5 |
| 1-349 | Prothioconazole | Pyraclostrobin |
| 1-350 | Prothioconazole | Azoxystrobin |
| 1-351 | Prothioconazole | Trifloxystrobin |
| 1-352 | Prothioconazole | Thiram |
| 1-353 | Prothioconazole | Flutolanil |
| 1-354 | Prothioconazole | Sedaxane |
| 1-355 | Prothioconazole | Penflufen |
| 1-356 | Prothioconazole | Fluxapyroxad |
| 1-357 | Prothioconazole | Bacillus firmus |
| 1-358 | Prothioconazole | Pasteuria penetrans |
| 1-359 | Prothioconazole | Tolclophos-methyl |
| 1-360 | Prothioconazole | Ethaboxam |
| 1-361 | Prothioconazole | Compound 4 |
| 1-362 | Prothioconazole | Compound 2 |
| 1-363 | Prothioconazole | Compound 3 |
| 1-364 | Prothioconazole | Compound 1 |
| 1-365 | Prothioconazole | Compound 5 |
| 1-366 | Fipronil | Tefluthrin |
| 1-367 | Imidacloprid | Tefluthrin |
| 1-368 | Carboxin | Thiram |
| 1-369 | Pyraclostrobin | Fluxapyroxad |
| 1-370 | Flutolanil | Mancozeb |
| 1-371 | Fluquinconazole | Prochloraz |

| | |
|---|---|
| Number of | |
| combination | Combinations of compounds |

| | | |
|---|---|---|
| 2-1 | Combination of 1-14 | Pyraclostrobin |
| 2-2 | Combination of 1-14 | Azoxystrobin |
| 2-3 | Combination of 1-14 | Trifloxystrobin |
| 2-4 | Combination of 1-14 | Compound 1 |
| 2-5 | Combination of 1-14 | Metconazole |
| 2-6 | Combination of 1-14 | Prothioconazole |
| 2-7 | Combination of 1-14 | Triticonazole |
| 2-8 | Combination of 1-14 | Tebuconazole |
| 2-9 | Combination of 1-14 | Diphenoconazole |
| 2-10 | Combination of 1-14 | Ipconazole |
| 2-11 | Combination of 1-14 | Thiophanate-methyl |
| 2-12 | Combination of 1-14 | Fludioxonil |
| 2-13 | Combination of 1-14 | Tolclophos-methyl |
| 2-14 | Combination of 1-14 | Thiram |
| 2-15 | Combination of 1-14 | Captan |
| 2-16 | Combination of 1-14 | Carboxin |
| 2-17 | Combination of 1-14 | Boscalid |
| 2-18 | Combination of 1-14 | Thiabendazole |
| 2-19 | Combination of 1-14 | Ethaboxam |
| 2-20 | Combination of 1-15 | Pyraclostrobin |
| 2-21 | Combination of 1-15 | Azoxystrobin |
| 2-22 | Combination of 1-15 | Trifloxystrobin |
| 2-23 | Combination of 1-15 | Compound 1 |
| 2-24 | Combination of 1-15 | Metconazole |
| 2-25 | Combination of 1-15 | Prothioconazole |
| 2-26 | Combination of 1-15 | Triticonazole |
| 2-27 | Combination of 1-15 | Tebuconazole |
| 2-28 | Combination of 1-15 | Diphenoconazole |
| 2-29 | Combination of 1-15 | Ipconazole |
| 2-30 | Combination of 1-15 | Thiophanate-methyl |
| 2-31 | Combination of 1-15 | Fludioxonil |
| 2-32 | Combination of 1-15 | Tolclophos-methyl |
| 2-33 | Combination of 1-15 | Thiram |
| 2-34 | Combination of 1-15 | Captan |
| 2-35 | Combination of 1-15 | Carboxin |
| 2-36 | Combination of 1-15 | Boscalid |
| 2-37 | Combination of 1-15 | Thiabendazole |
| 2-38 | Combination of 1-15 | Ethaboxam |
| 2-39 | Combination of 1-18 | Pyraclostrobin |
| 2-40 | Combination of 1-18 | Azoxystrobin |
| 2-41 | Combination of 1-18 | Trifloxystrobin |
| 2-42 | Combination of 1-18 | Compound 1 |
| 2-43 | Combination of 1-18 | Metconazole |
| 2-44 | Combination of 1-18 | Prothioconazole |
| 2-45 | Combination of 1-18 | Triticonazole |
| 2-46 | Combination of 1-18 | Tebuconazole |
| 2-47 | Combination of 1-18 | Diphenoconazole |
| 2-48 | Combination of 1-18 | Ipconazole |
| 2-49 | Combination of 1-18 | Thiophanate-methyl |
| 2-50 | Combination of 1-18 | Fludioxonil |
| 2-51 | Combination of 1-18 | Tolclophos-methyl |
| 2-52 | Combination of 1-18 | Thiram |
| 2-53 | Combination of 1-18 | Captan |
| 2-54 | Combination of 1-18 | Carboxin |
| 2-55 | Combination of 1-18 | Boscalid |
| 2-56 | Combination of 1-18 | Thiabendazole |
| 2-57 | Combination of 1-28 | Boscalid |
| 2-58 | Combination of 1-28 | Metconazole |
| 2-59 | Combination of 1-28 | Ipconazole |
| 2-60 | Combination of 1-28 | Triticonazole |
| 2-61 | Combination of 1-28 | Tebuconazole |
| 2-62 | Combination of 1-28 | Thiabendazole |
| 2-63 | Combination of 1-28 | Carboxin |
| 2-64 | Combination of 1-28 | Penflufen |
| 2-65 | Combination of 1-28 | Sedaxane |
| 2-66 | Combination of 1-28 | Fluxapyroxad |
| 2-67 | Combination of 1-28 | Fluopyram |
| 2-68 | Combination of 1-28 | Thiram |
| 2-69 | Combination of 1-233 | Metconazole |
| 2-70 | Combination of 1-27 | Ipconazole |
| 2-71 | Combination of 1-14 | Compound 5 |
| 2-72 | Combination of 1-15 | Compound 5 |
| 2-73 | Combination of 1-28 | Compound 5 |
| 2-74 | Combination of 1-90 | Fludioxonil |
| 2-75 | Combination of 1-91 | Fludioxonil |
| 2-76 | Combination of 1-52 | Pyraclostrobin |
| 2-77 | Combination of 1-53 | Pyraclostrobin |
| 2-78 | Combination of 1-52 | Trifloxystrobin |
| 2-79 | Combination of 1-53 | Trifloxystrobin |
| 2-80 | Combination of 1-216 | Penflufen |
| 2-81 | Combination of 1-4 | Bacillus firmus |
| 2-82 | Combination of 1-52 | Tebuconazole |
| 2-83 | Combination of 1-53 | Tebuconazole |
| 2-84 | Combination of 1-42 | Triazoxide |
| 2-85 | Combination of 1-52 | Mycrobutanil |
| 2-86 | Combination of 1-53 | Mycrobutanil |

| Number of | | | | |
|---|---|---|---|---|
| combination | Combination of compounds | | | |
| 3-1 | Combination of 2-57 | Pyraclostrobin | Compound 1 | |
| 3-2 | Combination of 2-57 | Pyraclostrobin | Tolclophos-methyl | |
| 3-3 | Combination of 2-57 | Pyraclostrobin | Metconazole | |
| 3-4 | Combination of 2-57 | Pyraclostrobin | Metalaxyl | |
| 3-5 | Combination of 2-17 | Pyraclostrobin | Metconazole | |
| 3-6 | Combination of 2-36 | Pyraclostrobin | Metconazole | |
| 3-7 | Combination of 2-17 | Pyraclostrobin | Compound 1 | |
| 3-8 | Combination of 2-36 | Pyraclostrobin | Compound 1 | |
| 3-9 | Combination of 2-17 | Pyraclostrobin | Tolclophos-methyl | |
| 3-10 | Combination of 2-36 | Pyraclostrobin | Tolclophos-methyl | |
| 3-11 | Combination of 2-10 | Thiram | | |
| 3-12 | Combination of 2-14 | Trifloxystrobin | | |
| 3-13 | Combination of 2-33 | Trifloxystrobin | | |
| 3-14 | Combination of 2-24 | Trifloxystrobin | | |
| 3-15 | Combination of 2-22 | Compound 1 | | |
| 3-16 | Combination of 2-23 | Azoxystrobin | | |
| 3-17 | Combination of 2-23 | Thiabendazole | | |
| 3-18 | Combination of 2-32 | Trifloxystrobin | | |
| 3-19 | Combination of 2-32 | Azoxystrobin | | |
| 3-20 | Combination of 2-32 | Thiabendazole | | |
| 3-21 | Combination of 2-19 | Trifloxystrobin | Compound 1 | |
| 3-22 | Combination of 2-19 | Azoxystrobin | Compound 1 | |
| 3-23 | Combination of 2-29 | Thiram | Compound 1 | |
| 3-24 | Combination of 2-29 | Tolclophos-methyl | | |
| 3-25 | Combination of 2-5 | Ethaboxam | Compound 1 | |
| 3-26 | Combination of 2-58 | Compound 1 | | |
| 3-27 | Combination of 2-58 | Diphenoconazole | | |
| 3-28 | Combination of 2-5 | Diphenoconazole | | |
| 3-29 | Combination of 2-24 | Diphenoconazole | | |
| 3-30 | Combination of 2-59 | Diphenoconazole | | |
| 3-31 | Combination of 2-60 | Diphenoconazole | | |
| 3-32 | Combination of 2-61 | Diphenoconazole | | |
| 3-33 | Combination of 2-62 | Diphenoconazole | | |
| 3-34 | Combination of 2-63 | Diphenoconazole | | |
| 3-35 | Combination of 2-64 | Diphenoconazole | | |
| 3-36 | Combination of 2-65 | Diphenoconazole | | |
| 3-37 | Combination of 2-66 | Diphenoconazole | | |
| 3-38 | Combination of 2-67 | Diphenoconazole | | |
| 3-39 | Combination of 2-68 | Diphenoconazole | | |
| 3-40 | Combination of 2-19 | Metconazole | Diphenoconazole | |
| 3-41 | Combination of 2-19 | Ipconazole | Diphenoconazole | |
| 3-42 | Combination of 2-19 | Triticonazole | Diphenoconazole | |
| 3-43 | Combination of 2-19 | Tebuconazole | Diphenoconazole | |
| 3-44 | Combination of 2-19 | Thiabendazole | Diphenoconazole | |
| 3-45 | Combination of 2-19 | Carboxin | Diphenoconazole | |
| 3-46 | Combination of 2-19 | Penflufen | Diphenoconazole | |
| 3-47 | Combination of 2-19 | Sedaxane | Diphenoconazole | |
| 3-48 | Combination of 2-19 | Fluxapyroxad | Diphenoconazole | |
| 3-49 | Combination of 2-19 | Fluopyram | Diphenoconazole | |
| 3-50 | Combination of 2-19 | Thiram | Diphenoconazole | |
| 3-51 | Combination of 2-17 | Pyraclostrobin | Ipconazole | |
| 3-52 | Combination of 2-36 | Pyraclostrobin | Ipconazole | |
| 3-53 | Combination of 2-57 | Pyraclostrobin | Ipconazole | |
| 3-54 | Combination of 2-10 | Trifloxystrobin | | |
| 3-55 | Combination of 2-29 | Trifloxystrobin | | |
| 3-56 | Combination of 2-59 | Trifloxystrobin | | |
| 3-57 | Combination of 2-19 | Ipconazole | Trifloxystrobin | |
| 3-58 | Combination of 2-29 | Azoxystrobin | | |
| 3-59 | Combination of 2-59 | Azoxystrobin | | |
| 3-60 | Combination of 2-19 | Ipconazole | Azoxystrobin | |
| 3-61 | Combination of 2-5 | Compound 1 | Carboxin | |
| 3-62 | Combination of 2-5 | Compound 1 | Penflufen | |
| 3-63 | Combination of 2-5 | Compound 1 | Sedaxane | |
| 3-64 | Combination of 2-5 | Compound 1 | Fluxapyroxad | |
| 3-65 | Combination of 2-5 | Compound 1 | Fluopyram | |
| 3-66 | Combination of 2-5 | Compound 1 | Oxycarboxin | |
| 3-67 | Combination of 2-5 | Compound 1 | Thifluzamide | |
| 3-68 | Combination of 2-5 | Compound 1 | Flutolanil | |
| 3-69 | Combination of 2-5 | Compound 1 | Pencycuron | |
| 3-70 | Combination of 2-5 | Compound 1 | Fludioxonil | |
| 3-71 | Combination of 2-32 | Compound 1 | Metconazole | |
| 3-72 | Combination of 2-32 | Compound 1 | Tebuconazole | |
| 3-73 | Combination of 2-32 | Compound 1 | Diphenoconazole | |
| 3-74 | Combination of 2-32 | Compound 1 | Triticonazole | |
| 3-75 | Combination of 2-32 | Compound 1 | Imazalil | |
| 3-76 | Combination of 2-32 | Compound 1 | Triadimenol | |
| 3-77 | Combination of 2-32 | Compound 1 | Fluquinconazole | |
| 3-78 | Combination of 2-32 | Compound 1 | Prochloraz | |
| 3-79 | Combination of 2-32 | Compound 1 | Prothioconazole | |
| 3-80 | Combination of 2-32 | Compound 1 | Diniconazole | |
| 3-81 | Combination of 2-32 | Compound 1 | Diniconazole-M | |
| 3-82 | Combination of 2-32 | Compound 1 | Ipconazole | |
| 3-83 | Combination of 2-32 | Compound 1 | Cyproconazole | |
| 3-84 | Combination of 2-32 | Compound 1 | Tetraconazole | |
| 3-85 | Combination of 2-32 | Compound 1 | Carboxin | |
| 3-86 | Combination of 2-32 | Compound 1 | Penflufen | |
| 3-87 | Combination of 2-32 | Compound 1 | Sedaxane | |
| 3-88 | Combination of 2-32 | Compound 1 | Fluxapyroxad | |
| 3-89 | Combination of 2-32 | Compound 1 | Fluopyram | |
| 3-90 | Combination of 2-32 | Compound 1 | Oxycarboxin | |
| 3-91 | Combination of 2-32 | Compound 1 | Fludioxonil | |
| 3-92 | Combination of 2-32 | Compound 1 | Thiram | |
| 3-93 | Combination of 2-32 | Compound 1 | Captan | |
| 3-94 | Combination of 2-32 | Compound 1 | Thiophanate-methyl | |
| 3-95 | Combination of 2-32 | Compound 1 | Thiabendazole | |
| 3-96 | Combination of 2-13 | Compound 1 | Metconazole | |
| 3-97 | Combination of 2-13 | Compound 1 | Tebuconazole | |
| 3-98 | Combination of 2-13 | Compound 1 | Diphenoconazole | |
| 3-99 | Combination of 2-13 | Compound 1 | Triticonazole | |
| 3-100 | Combination of 2-13 | Compound 1 | Imazalil | |
| 3-101 | Combination of 2-13 | Compound 1 | Triadimenol | |
| 3-102 | Combination of 2-13 | Compound 1 | Fluquinconazole | |
| 3-103 | Combination of 2-13 | Compound 1 | Prochloraz | |
| 3-104 | Combination of 2-13 | Compound 1 | Prothioconazole | |
| 3-105 | Combination of 2-13 | Compound 1 | Diniconazole | |
| 3-106 | Combination of 2-13 | Compound 1 | Diniconazole-M | |
| 3-107 | Combination of 2-13 | Compound 1 | Ipconazole | |
| 3-108 | Combination of 2-13 | Compound 1 | Cyproconazole | |
| 3-109 | Combination of 2-13 | Compound 1 | Tetraconazole | |
| 3-110 | Combination of 2-13 | Compound 1 | Carboxin | |
| 3-111 | Combination of 2-13 | Compound 1 | Penflufen | |
| 3-112 | Combination of 2-13 | Compound 1 | Sedaxane | |
| 3-113 | Combination of 2-13 | Compound 1 | Fluxapyroxad | |
| 3-114 | Combination of 2-13 | Compound 1 | Fluopyram | |
| 3-115 | Combination of 2-13 | Compound 1 | Oxycarboxin | |
| 3-116 | Combination of 2-13 | Compound 1 | Fludioxonil | |
| 3-117 | Combination of 2-13 | Compound 1 | Thiram | |
| 3-118 | Combination of 2-13 | Compound 1 | Captan | |
| 3-119 | Combination of 2-13 | Compound 1 | Thiophanate-methyl | |
| 3-120 | Combination of 2-13 | Compound 1 | Thiabendazole | |
| 3-121 | Combination of 2-69 | Compound 1 | Oxadixyl | |
| 3-122 | Combination of 2-69 | Compound 1 | Hymexazol | |
| 3-123 | Combination of 2-69 | Compound 1 | Fenamidone | |
| 3-124 | Combination of 2-69 | Compound 1 | Cymoxanil | |
| 3-125 | Combination of 2-69 | Compound 1 | Fluopicolide | |
| 3-126 | Combination of 2-70 | Carboxin | | |
| 3-127 | Combination of 2-10 | Tolclophos-methyl | Carboxin | |
| 3-128 | Combination of 2-10 | Tolclophos-methyl | Penflufen | |
| 3-129 | Combination of 2-10 | Tolclophos-methyl | Sedaxane | |
| 3-130 | Combination of 2-10 | Tolclophos-methyl | Fluxapyroxad | |
| 3-131 | Combination of 2-10 | Tolclophos-methyl | Fluopyram | |
| 3-132 | Combination of 2-5 | Tolclophos-methyl | | |
| 3-133 | Combination of 2-5 | Tolclophos-methyl | Azoxystrobin | |
| 3-134 | Combination of 2-5 | Tolclophos-methyl | Fluoxastrobin | |
| 3-135 | Combination of 2-5 | Tolclophos-methyl | Trifloxystrobin | |
| 3-136 | Combination of 2-5 | Tolclophos-methyl | Pyraclostrobin | |
| 3-137 | Combination of 2-5 | Tolclophos-methyl | Orysastrobin | |
| 3-138 | Combination of 2-5 | Tolclophos-methyl | Carboxin | |
| 3-139 | Combination of 2-5 | Tolclophos-methyl | Oxycarboxin | |
| 3-140 | Combination of 2-5 | Tolclophos-methyl | Fludioxonil | |
| 3-141 | Combination of 2-5 | Tolclophos-methyl | Thiram | |
| 3-142 | Combination of 2-5 | Tolclophos-methyl | Captan | |
| 3-143 | Combination of 2-5 | Tolclophos-methyl | Thiophanate-methyl | |
| 3-144 | Combination of 2-5 | Tolclophos-methyl | Thiabendazole | |
| 3-145 | Combination of 2-5 | Ethaboxam | | |
| 3-146 | Combination of 2-5 | Ethaboxam | Tolclophos-methyl | |
| 3-147 | Combination of 2-38 | Compound 1 | Compound 2 | |
| 3-148 | Combination of 2-19 | Compound 1 | Compound 2 | |
| 3-149 | Combination of 2-19 | Compound 5 | Compound 2 | |
| 3-150 | Combination of 2-38 | Compound 5 | Compound 2 | |
| 3-151 | Combination of 2-19 | Ipconazole | Compound 3 | |
| 3-152 | Combination of 2-38 | Ipconazole | Compound 3 | |
| 3-153 | Combination of 2-19 | Metconazole | Compound 3 | |
| 3-154 | Combination of 2-38 | Metconazole | Compound 3 | |
| 3-155 | Combination of 2-19 | Tolclophos-methyl | Compound 3 | |
| 3-156 | Combination of 2-38 | Tolclophos-methyl | Compound 3 | |
| 3-157 | Combination of 2-19 | Compound 1 | Compound 3 | |
| 3-158 | Combination of 2-38 | Compound 1 | Compound 3 | |
| 3-159 | Combination of 2-19 | Compound 1 | Compound 3 | |
| 3-160 | Combination of 2-38 | Compound 1 | Compound 3 | |
| 3-161 | Combination of 2-19 | Compound 5 | Compound 3 | |
| 3-162 | Combination of 2-38 | Fludioxonil | Compound 3 | |
| 3-163 | Combination of 2-38 | Compound 5 | Compound 3 | |
| 3-164 | Combination of 2-19 | Tolclophos-methyl | Compound 4 | |
| 3-165 | Combination of 2-38 | Metconazole | Compound 4 | |
| 3-166 | Combination of 2-38 | Compound 4 | Compound 5 | |
| 3-167 | Combination of 2-38 | Compound 4 | Compound 1 | |
| 3-168 | Combination of 2-19 | Ipconazole | Compound 4 | |
| 3-169 | Combination of 2-19 | Compound 4 | Compound 5 | |
| 3-170 | Combination of 2-19 | Boscalid | Pyraclostrobin | Metconazole |
| 3-171 | Combination of 2-19 | Boscalid | Pyraclostrobin | Ipconazole |
| 3-172 | Combination of 2-38 | Boscalid | Pyraclostrobin | Metconazole |
| 3-173 | Combination of 2-19 | Boscalid | Pyraclostrobin | Compound 1 |
| 3-174 | Combination of 2-38 | Boscalid | Pyraclostrobin | Compound 1 |
| 3-175 | Combination of 2-19 | Boscalid | Pyraclostrobin | Tolclophos-methyl |
| 3-176 | Combination of 2-38 | Boscalid | Pyraclostrobin | Tolclophos-methyl |
| 3-177 | Combination of 2-32 | Compound 1 | Metconazole | Oxadixyl |
| 3-178 | Combination of 2-32 | Compound 1 | Metconazole | Hymexazol |
| 3-179 | Combination of 2-32 | Compound 1 | Metconazole | Fenamidone |
| 3-180 | Combination of 2-32 | Compound 1 | Metconazole | Cymoxanil |
| 3-181 | Combination of 2-32 | Compound 1 | Metconazole | Fluopicolide |
| 3-182 | Combination of 2-13 | Compound 1 | Metconazole | Oxadixyl |
| 3-183 | Combination of 2-13 | Compound 1 | Metconazole | Hymexazol |
| 3-184 | Combination of 2-13 | Compound 1 | Metconazole | Fenamidone |
| 3-185 | Combination of 2-13 | Compound 1 | Metconazole | Cymoxanil |
| 3-186 | Combination of 2-13 | Compound 1 | Metconazole | Fluopicolide |
| 3-187 | Combination of 2-5 | Ethaboxam | Tolclophos-methyl | Azoxystrobin |
| 3-188 | Combination of 2-5 | Ethaboxam | Tolclophos-methyl | Fluoxastrobin |
| 3-189 | Combination of 2-5 | Ethaboxam | Tolclophos-methyl | Trifloxystrobin |
| 3-190 | Combination of 2-5 | Ethaboxam | Tolclophos-methyl | Pyraclostrobin |
| 3-191 | Combination of 2-5 | Ethaboxam | Tolclophos-methyl | Orysastrobin |
| 3-192 | Combination of 2-5 | Ethaboxam | Tolclophos-methyl | Carboxin |
| 3-193 | Combination of 2-5 | Ethaboxam | Tolclophos-methyl | Penflufen |
| 3-194 | Combination of 2-5 | Ethaboxam | Tolclophos-methyl | Sedaxane |
| 3-195 | Combination of 2-5 | Ethaboxam | Tolclophos-methyl | Fluxapyroxad |
| 3-196 | Combination of 2-19 | Ipconazole | Compound 2 | Fluopyram |
| 3-197 | Combination of 2-38 | Ipconazole | Compound 2 | Oxycarboxin |
| 3-198 | Combination of 2-19 | Metconazole | Compound 2 | Fludioxonil |
| 3-199 | Combination of 2-38 | Metconazole | Compound 2 | Thiram |
| 3-200 | Combination of 2-19 | Tolclophos-methyl | Compound 2 | Captan |
| 3-201 | Combination of 2-38 | Tolclophos-methyl | Compound 2 | Thiophanate-methyl |
| 3-202 | Combination of 2-19 | Compound 1 | Compound 2 | Thiabendazole |
| 3-203 | Combination of 2-72 | Metconazole | | |
| 3-204 | Combination of 2-71 | Metconazole | | |
| 3-205 | Combination of 2-73 | Diphenoconazole | | |
| 3-206 | Combination of 2-73 | Triticonazole | | |
| 3-207 | Combination of 2-73 | Tebuconazole | | |
| 3-208 | Combination of 2-73 | Thiabendazole | | |
| 3-209 | Combination of 2-73 | Carboxin | | |
| 3-210 | Combination of 2-73 | Thiram | | |
| 3-211 | Combination of 2-73 | Captan | | |
| 3-212 | Combination of 2-71 | Compound 1 | | |
| 3-213 | Combination of 2-72 | Compound 1 | | |
| 3-214 | Combination of 2-73 | Compound 1 | | |
| 3-215 | Combination of 2-71 | Tolclophos-methyl | | |
| 3-216 | Combination of 2-72 | Tolclophos-methyl | | |
| 3-217 | Combination of 2-71 | Captan | | |
| 3-218 | Combination of 2-72 | Captan | | |
| 3-219 | Combination of 2-71 | Ethaboxam | Metconazole | |
| 3-220 | Combination of 2-71 | Ethaboxam | Compound 1 | |
| 3-221 | Combination of 2-71 | Ethaboxam | Tolclophos-methyl | |
| 3-222 | Combination of 2-73 | Tolclophos-methyl | | |
| 3-223 | Combination of 2-71 | Ethaboxam | Ipconazole | |
| 3-224 | Combination of 2-71 | Ethaboxam | Diphenoconazole | |
| 3-225 | Combination of 2-71 | Ethaboxam | Triticonazole | |
| 3-226 | Combination of 2-71 | Ethaboxam | Tebuconazole | |
| 3-227 | Combination of 2-71 | Ethaboxam | Thiabendazole | |
| 3-228 | Combination of 2-71 | Ethaboxam | Carboxin | |
| 3-229 | Combination of 2-71 | Ethaboxam | Thiram | |
| 3-230 | Combination of 2-71 | Ethaboxam | Captan | |
| 3-231 | Combination of 2-73 | Ipconazole | | |
| 3-232 | Combination of 2-71 | Fludioxonil | Azoxystrobin | Prothioconazole |
| 3-233 | Combination of 2-71 | Fludioxonil | Pyraclostrobin | Prothioconazole |
| 3-234 | Combination of 2-71 | Fludioxonil | Trifloxystrobin | Prothioconazole |
| 3-235 | Combination of 2-71 | Fludioxonil | Fluoxastrobin | Prothioconazole |
| 3-236 | Combination of 2-71 | Fludioxonil | Azoxystrobin | Triticonazole |
| 3-237 | Combination of 2-71 | Fludioxonil | Pyraclostrobin | Triticonazole |
| 3-238 | Combination of 2-71 | Fludioxonil | Trifloxystrobin | Triticonazole |
| 3-239 | Combination of 2-71 | Fludioxonil | Fluoxastrobin | Triticonazole |
| 3-240 | Combination of 2-71 | Fludioxonil | Azoxystrobin | Tebuconazole |
| 3-241 | Combination of 2-71 | Fludioxonil | Pyraclostrobin | Tebuconazole |
| 3-242 | Combination of 2-71 | Fludioxonil | Trifloxystrobin | Tebuconazole |
| 3-243 | Combination of 2-71 | Fludioxonil | Fluoxastrobin | Tebuconazole |
| 3-244 | Combination of 2-71 | Fludioxonil | Azoxystrobin | Diphenoconazole |
| 3-245 | Combination of 2-71 | Fludioxonil | Pyraclostrobin | Diphenoconazole |
| 3-246 | Combination of 2-71 | Fludioxonil | Trifloxystrobin | Diphenoconazole |
| 3-247 | Combination of 2-71 | Fludioxonil | Fluoxastrobin | Diphenoconazole |
| 3-248 | Combination of 2-72 | Fludioxonil | Azoxystrobin | Prothioconazole |
| 3-249 | Combination of 2-72 | Fludioxonil | Pyraclostrobin | Prothioconazole |
| 3-250 | Combination of 2-72 | Fludioxonil | Trifloxystrobin | Prothioconazole |
| 3-251 | Combination of 2-72 | Fludioxonil | Fluoxastrobin | Prothioconazole |
| 3-252 | Combination of 2-72 | Fludioxonil | Azoxystrobin | Triticonazole |
| 3-253 | Combination of 2-72 | Fludioxonil | Pyraclostrobin | Triticonazole |
| 3-254 | Combination of 2-72 | Fludioxonil | Trifloxystrobin | Triticonazole |
| 3-255 | Combination of 2-72 | Fludioxonil | Fluoxastrobin | Triticonazole |
| 3-256 | Combination of 2-72 | Fludioxonil | Azoxystrobin | Tebuconazole |
| 3-257 | Combination of 2-72 | Fludioxonil | Pyraclostrobin | Tebuconazole |
| 3-258 | Combination of 2-72 | Fludioxonil | Trifloxystrobin | Tebuconazole |
| 3-259 | Combination of 2-72 | Fludioxonil | Fluoxastrobin | Tebuconazole |
| 3-260 | Combination of 2-72 | Fludioxonil | Azoxystrobin | Diphenoconazole |
| 3-261 | Combination of 2-72 | Fludioxonil | Pyraclostrobin | Diphenoconazole |
| 3-262 | Combination of 2-72 | Fludioxonil | Trifloxystrobin | Diphenoconazole |
| 3-263 | Combination of 2-72 | Fludioxonil | Fluoxastrobin | Diphenoconazole |
| 3-264 | Combination of 2-71 | Compound 1 | Compound 2 | |
| 3-265 | Combination of 2-71 | Pyraclostrobin | Compound 2 | |
| 3-266 | Combination of 2-71 | Azoxystrobin | Compound 2 | |
| 3-267 | Combination of 2-71 | Trifloxystrobin | Compound 2 | |
| 3-268 | Combination of 2-71 | Metconazole | Compound 2 | |
| 3-269 | Combination of 2-71 | Prothioconazole | Compound 2 | |
| 3-270 | Combination of 2-71 | Triticonazole | Compound 2 | |
| 3-271 | Combination of 2-71 | Tebuconazole | Compound 2 | |
| 3-272 | Combination of 2-71 | Diphenoconazole | Compound 2 | |
| 3-273 | Combination of 2-71 | Ipconazole | Compound 2 | |
| 3-274 | Combination of 2-71 | Thiophanate-methyl | Compound 2 | |
| 3-275 | Combination of 2-71 | Fludioxonil | Compound 2 | |
| 3-276 | Combination of 2-71 | Tolclophos-methyl | Compound 2 | |
| 3-277 | Combination of 2-71 | Thiuram | Compound 2 | |
| 3-278 | Combination of 2-71 | Captan | Compound 2 | |
| 3-279 | Combination of 2-71 | Carboxin | Compound 2 | |
| 3-280 | Combination of 2-71 | Penflufen | Compound 2 | |
| 3-281 | Combination of 2-71 | Sedaxane | Compound 2 | |
| 3-282 | Combination of 2-71 | Fluxapyroxad | Compound 2 | |
| 3-283 | Combination of 2-71 | Fluopyram | Compound 2 | |
| 3-284 | Combination of 2-71 | Boscalid | Compound 2 | |
| 3-285 | Combination of 2-71 | Thiabendazole | Compound 2 | |
| 3-286 | Combination of 2-72 | Compound 1 | Compound 2 | |
| 3-287 | Combination of 2-72 | Pyraclostrobin | Compound 2 | |
| 3-288 | Combination of 2-72 | Azoxystrobin | Compound 2 | |
| 3-289 | Combination of 2-72 | Trifloxystrobin | Compound 2 | |
| 3-290 | Combination of 2-72 | Metconazole | Compound 2 | |
| 3-291 | Combination of 2-72 | Prothioconazole | Compound 2 | |
| 3-292 | Combination of 2-72 | Triticonazole | Compound 2 | |
| 3-293 | Combination of 2-72 | Tebuconazole | Compound 2 | |
| 3-294 | Combination of 2-72 | Diphenoconazole | Compound 2 | |
| 3-295 | Combination of 2-72 | Ipconazole | Compound 2 | |
| 3-296 | Combination of 2-72 | Thiophanate-methyl | Compound 2 | |
| 3-297 | Combination of 2-72 | Fludioxonil | Compound 2 | |
| 3-298 | Combination of 2-72 | Tolclophos-methyl | Compound 2 | |
| 3-299 | Combination of 2-72 | Thiuram | Compound 2 | |
| 3-300 | Combination of 2-72 | Captan | Compound 2 | |
| 3-301 | Combination of 2-72 | Carboxin | Compound 2 | |
| 3-302 | Combination of 2-72 | Penflufen | Compound 2 | |
| 3-303 | Combination of 2-72 | Sedaxane | Compound 2 | |
| 3-304 | Combination of 2-72 | Fluxapyroxad | Compound 2 | |
| 3-305 | Combination of 2-72 | Fluopyram | Compound 2 | |
| 3-306 | Combination of 2-72 | Boscalid | Compound 2 | |
| 3-307 | Combination of 2-72 | Thiabendazole | Compound 2 | |
| 3-308 | Combination of 2-71 | Compound 1 | Compound 3 | |
| 3-309 | Combination of 2-71 | Pyraclostrobin | Compound 3 | |
| 3-310 | Combination of 2-71 | Azoxystrobin | Compound 3 | |
| 3-311 | Combination of 2-71 | Trifloxystrobin | Compound 3 | |
| 3-312 | Combination of 2-71 | Metconazole | Compound 3 | |
| 3-313 | Combination of 2-71 | Prothioconazole | Compound 3 | |
| 3-314 | Combination of 2-71 | Triticonazole | Compound 3 | |
| 3-315 | Combination of 2-71 | Tebuconazole | Compound 3 | |
| 3-316 | Combination of 2-71 | Diphenoconazole | Compound 3 | |
| 3-317 | Combination of 2-71 | Ipconazole | Compound 3 | |
| 3-318 | Combination of 2-71 | Thiophanate-methyl | Compound 3 | |
| 3-319 | Combination of 2-71 | Fludioxonil | Compound 3 | |
| 3-320 | Combination of 2-71 | Tolclophos-methyl | Compound 3 | |
| 3-321 | Combination of 2-71 | Thiuram | Compound 3 | |
| 3-322 | Combination of 2-71 | Captan | Compound 3 | |
| 3-323 | Combination of 2-71 | Carboxin | Compound 3 | |
| 3-324 | Combination of 2-71 | Penflufen | Compound 3 | |
| 3-325 | Combination of 2-71 | Sedaxane | Compound 3 | |
| 3-326 | Combination of 2-71 | Fluxapyroxad | Compound 3 | |
| 3-327 | Combination of 2-71 | Fluopyram | Compound 3 | |
| 3-328 | Combination of 2-71 | Boscalid | Compound 3 | |
| 3-329 | Combination of 2-71 | Thiabendazole | Compound 3 | |
| 3-330 | Combination of 2-72 | Compound 1 | Compound 3 | |
| 3-331 | Combination of 2-72 | Pyraclostrobin | Compound 3 | |
| 3-332 | Combination of 2-72 | Azoxystrobin | Compound 3 | |
| 3-333 | Combination of 2-72 | Trifloxystrobin | Compound 3 | |
| 3-334 | Combination of 2-72 | Metconazole | Compound 3 | |
| 3-335 | Combination of 2-72 | Prothioconazole | Compound 3 | |
| 3-336 | Combination of 2-72 | Triticonazole | Compound 3 | |
| 3-337 | Combination of 2-72 | Tebuconazole | Compound 3 | |
| 3-338 | Combination of 2-72 | Diphenoconazole | Compound 3 | |
| 3-339 | Combination of 2-72 | Ipconazole | Compound 3 | |
| 3-340 | Combination of 2-72 | Thiophanate-methyl | Compound 3 | |
| 3-341 | Combination of 2-72 | Fludioxonil | Compound 3 | |
| 3-342 | Combination of 2-72 | Tolclophos-methyl | Compound 3 | |
| 3-343 | Combination of 2-72 | Thiuram | Compound 3 | |
| 3-344 | Combination of 2-72 | Captan | Compound 3 | |
| 3-345 | Combination of 2-72 | Carboxin | Compound 3 | |
| 3-346 | Combination of 2-72 | Penflufen | Compound 3 | |
| 3-347 | Combination of 2-72 | Sedaxane | Compound 3 | |
| 3-348 | Combination of 2-72 | Fluxapyroxad | Compound 3 | |
| 3-349 | Combination of 2-72 | Fluopyram | Compound 3 | |
| 3-350 | Combination of 2-72 | Boscalid | Compound 3 | |
| 3-351 | Combination of 2-72 | Thiabendazole | Compound 3 | |
| 3-352 | Combination of 2-71 | Compound 1 | Compound 4 | |
| 3-353 | Combination of 2-71 | Pyraclostrobin | Compound 4 | |
| 3-354 | Combination of 2-71 | Azoxystrobin | Compound 4 | |
| 3-355 | Combination of 2-71 | Trifloxystrobin | Compound 4 | |
| 3-356 | Combination of 2-71 | Metconazole | Compound 4 | |
| 3-357 | Combination of 2-71 | Prothioconazole | Compound 4 | |
| 3-358 | Combination of 2-71 | Triticonazole | Compound 4 | |
| 3-359 | Combination of 2-71 | Tebuconazole | Compound 4 | |
| 3-360 | Combination of 2-71 | Diphenoconazole | Compound 4 | |
| 3-361 | Combination of 2-71 | Ipconazole | Compound 4 | |
| 3-362 | Combination of 2-71 | Thiophanate-methyl | Compound 4 | |
| 3-363 | Combination of 2-71 | Fludioxonil | Compound 4 | |
| 3-364 | Combination of 2-71 | Tolclophos-methyl | Compound 4 | |
| 3-365 | Combination of 2-71 | Thiuram | Compound 4 | |
| 3-366 | Combination of 2-71 | Captan | Compound 4 | |
| 3-367 | Combination of 2-71 | Carboxin | Compound 4 | |
| 3-368 | Combination of 2-71 | Penflufen | Compound 4 | |
| 3-369 | Combination of 2-71 | Sedaxane | Compound 4 | |
| 3-370 | Combination of 2-71 | Fluxapyroxad | Compound 4 | |
| 3-371 | Combination of 2-71 | Fluopyram | Compound 4 | |
| 3-372 | Combination of 2-71 | Boscalid | Compound 4 | |
| 3-373 | Combination of 2-71 | Thiabendazole | Compound 4 | |
| 3-374 | Combination of 2-72 | Compound 1 | Compound 4 | |
| 3-375 | Combination of 2-72 | Pyraclostrobin | Compound 4 | |
| 3-376 | Combination of 2-72 | Azoxystrobin | Compound 4 | |
| 3-377 | Combination of 2-72 | Trifloxystrobin | Compound 4 | |
| 3-378 | Combination of 2-72 | Metconazole | Compound 4 | |
| 3-379 | Combination of 2-72 | Prothioconazole | Compound 4 | |
| 3-380 | Combination of 2-72 | Triticonazole | Compound 4 | |
| 3-381 | Combination of 2-72 | Tebuconazole | Compound 4 | |
| 3-382 | Combination of 2-72 | Diphenoconazole | Compound 4 | |
| 3-383 | Combination of 2-72 | Ipconazole | Compound 4 | |
| 3-384 | Combination of 2-72 | Thiophanate-methyl | Compound 4 | |
| 3-385 | Combination of 2-72 | Fludioxonil | Compound 4 | |
| 3-386 | Combination of 2-72 | Tolclophos-methyl | Compound 4 | |
| 3-387 | Combination of 2-72 | Thiuram | Compound 4 | |
| 3-388 | Combination of 2-72 | Captan | Compound 4 | |
| 3-389 | Combination of 2-72 | Carboxin | Compound 4 | |
| 3-390 | Combination of 2-72 | Penflufen | Compound 4 | |
| 3-391 | Combination of 2-72 | Sedaxane | Compound 4 | |
| 3-392 | Combination of 2-72 | Fluxapyroxad | Compound 4 | |
| 3-393 | Combination of 2-72 | Fluopyram | Compound 4 | |
| 3-394 | Combination of 2-72 | Boscalid | Compound 4 | |
| 3-395 | Combination of 2-72 | Thiabendazole | Compound 4 | |
| 3-396 | Combination of 2-74 | Azoxystrobin | Abamectin | Sedaxane |
| 3-397 | Combination of 2-75 | Azoxystrobin | Abamectin | Sedaxane |
| 3-398 | Combination of 2-76 | Fluxapyroxad | | |
| 3-399 | Combination of 2-77 | Fluxapyroxad | | |
| 3-400 | Combination of 2-81 | Fluxapyroxad | | |
| 3-401 | Combination of 2-78 | Penflufen | | |
| 3-402 | Combination of 2-79 | Penflufen | | |
| 3-403 | Fipronil | Pyraclostrobin | Thiophanate-methyl | Fluxapyroxad |
| 3-404 | Fluoxastrobin | Prothioconazole | Tebuconazole | Triazoxide |
| 3-405 | Combination of 3-398 | Sedaxane | | |
| 3-406 | Combination of 3-399 | Sedaxane | | |
| 3-407 | Combination of 2-85 | Trifloxystrobin | Fluxapyroxad | Thiodicarb |
| 3-408 | Combination of 2-86 | Trifloxystrobin | Fluxapyroxad | Thiodicarb |
| 3-409 | Combination of 2-85 | Pyraclostrobin | Fluxapyroxad | Thiodicarb |
| 3-410 | Combination of 2-86 | Pyraclostrobin | Fluxapyroxad | Thiodicarb |

### Example 1

A pot is filled with soil and weeds are sowed, and the surface of the soil is uniformly treated with flumioxazin at a dose of 25, 50, 100, or 200 g/ha, with saflufenacil at a dose of 25, 50, 100, or 200 g/ha, with fomesafen at a dose of 100, 200, or 400 g/ha, or with oxyfluorfen at a dose of 200, 400, or 800 g/ha. After 15 days, cotton seeds are sowed to which each of the combinations of the compounds described in Tables 1 to 3 is attached at a dose of 1, 10, or 100 g/100 kg seeds. This pot is placed in a greenroom. The pest control effect, and crop phytotoxicity are examined 15 days after the cotton seeds are sowed.

### Example 2

Cotton seeds are sowed to which with each of the combinations of the compounds described in Tables 1 to 3 is attached at a dose of 1, 10, or 100 g/100 kg seeds. Then, these seeds are sowed in a cultivated field. The stem leaves of the
weeds are directly treated with flumioxazin at a dose of 25, 50, 100, 200, or 400 g/ha, with saflufenacil at a dose of 25, 50, 100, or 200 g/ha, with fomesafen at a dose of 100, 200, or 400 g/ha, or with oxyfluorfen at a dose of 200, 400, 800, or 1600 g/ha in the condition of the cotton main stem being lignified at a length of 15 cm from the surface of the ground 30 days after these seeds are sowed. This pot is placed in a greenroom. The pest control effect, herbicidal effect), and crop phytotoxicity are examined 28 days after this treatment.

### Example 3

A pot is filled with soil and weeds are sowed, and the surface of the soil is uniformly treated with flumioxazin at a dose of 25, 50, 100, or 200 g/ha, with sulfentrazone at a dose of 100, 200, or 400 g/ha, with saflufenacil at a dose of 25, 50, 100, or 200 g/ha, with fomesafen at a dose of 100, 200, or 400 g/ha, or with oxyfluorfen at a dose of 200, 400, or 800 g/ha. Soybean seeds are sowed to which each of the combinations of the compounds described in Tables 1 to 3 at a dose of 1, 10, or 100 g/100 kg seeds, 7 days after this treatment. This pot is placed in a greenroom. The pest control effect, and crop phytotoxicity are examined 15 days after the soybean seeds are sowed.

### Example 4

Each of the combinations of the compounds described in Tables 1 to 3 is attached to soybean seeds at a dose of 1, 10, or 100 g/100 kg seeds. Then, a pot is filled with soil and the soybean seeds and weed seeds are sowed. On the day of sowing, the surface of the soil is uniformly treated with flumioxazin at a dose of 25, 50, 100, or 200 g/ha, with sulfentrazone at a dose of 100, 200, or 400 g/ha, with saflufenacil at a dose of 25, 50, or 100 g/ha, or with fomesafen at a dose of 100, 200, or 400 g/ha. This pot is placed in a greenroom. The pest control effect, and crop phytotoxicity are examined 15 days after these seeds are sowed.

### Example 5

A pot is filled with soil and weeds are sowed, and the surface of the soil is uniformly treated with flumioxazin at a dose of 25, 50, 100, or 200 g/ha or with saflufenacil at a dose of 25, 50, 100, or 200 g/ha. Corn seeds are sowed to which each of the combinations of the compounds described in Tables 1 to 3 at a dose of 1, 10, or 100 g/100 kg seeds, 7 days after this treatment. This pot is placed in a greenroom. The pest control effect, and crop phytotoxicity are examined 15 days after the corn seeds are sowed.

### Example 6

Each of the combinations of the compounds described in Tables 1 to 3 is attached to corn seeds at a dose of 1, 10, or 100 g/100 kg seeds. Then, a pot is filled with soil and the corn seeds and weed seeds are sowed. On the day of sowing, the surface of the soil is uniformly treated with saflufenacil at a dose of 25, 50, 100, or 200 g/ha. This pot is placed in a greenroom. The pest control effect, and crop phytotoxicity are examined 15 days after these seeds are sowed.

According to the method of controlling pests of the present invention, pests in soybean fields, corn fields, or cotton fields can be efficiently controlled.

1. A method of controlling weeds in a soybean field, corn field, or cotton field, the method comprising treating the soybean field, corn field, or cotton field with one or more PPO-inhibiting compounds selected from flumioxazin, sulfentrazone, saflufenacil, oxyfluorfen and fomesafen-sodium,
before sowing, at the same time of sowing, or after sowing corn seeds, soybean seeds, or cotton seeds which are treated with two or more compounds selected from the following compound group A:
Compound group A: neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators.

2. A method of controlling pests in a soybean field, corn field, or cotton field, the method comprising the steps of:
treating soybean seeds, corn seeds, or cotton seeds with two or more compounds selected from the following compound group A:
Compound group A: neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators; and
treating the field with one or more PPO-inhibiting compounds selected from flumioxazin, sulfentrazone, saflufenacil, oxyfluorfen and fomesafen-sodium, before sowing, at the same time of sowing, or after sowing corn seeds, soybean seeds, or cotton seeds which are treated with the compounds of the compound group A.

3. The control method according to claim 2, wherein the pests are weeds.

4. The control method according to claim 1, wherein two or more compounds selected from the compound group A is two or more compounds selected from the following compound group A-1.
Compound group A-1:
neonicotinoid compounds: clothianidin, thiamethoxam, imidacloprid, dinotefuran, nitenpyram, acetamiprid, and thiacloprid;
diamide compounds: flubendiamide, chlorantraniliprole, cyantraniliprole, and compounds represented by the formula (II): 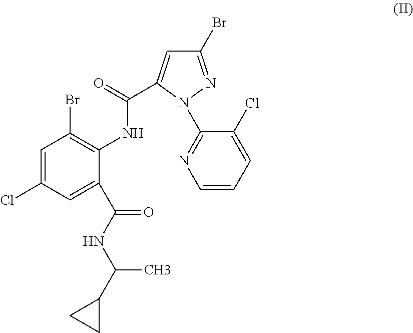 [SMILES: CC(NC(=O)c1cc(Cl)cc(Br)c1NC(=O)c1cc(Br)nn1-c1ncccc1Cl)C1CC1]
carbamate compounds: aldicarb, oxamyl, thiodicarb, carbofuran, carbosulfan, and dimethoate;
organic phosphorous compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
biological nematicidal compounds: Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;
other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
azole compounds: azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizole;
strobilurin compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxy-acetamide (racemic or enantiomer, containing a mixture of R-enantiomer and S-enantiomer (optional ratio));
metalaxyl compounds: metalaxyl and metalaxyl-M;
SDHI compounds: sedaxane, penflufen, carboxin, boscalid, furametpyr, flutolanil, fluxapyroxad, isopyrazam, fluopyram, and thifluzamide;
other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
plant growth regulators: ethephon, chlormequat-chloride, mepiquat-chloride, and 4-oxo-4-(2-phenylethyl)aminobutyric acid

5. The control method according to claim 1, the method comprising the step of treating the field with the PPO-inhibiting compound before the soybean seeds, corn seeds, or cotton seeds are sowed.

6. The control method according to claim 1, the method comprising the step of treating the field with the PPO-inhibiting compound at the same time of sowing the soybean seeds, corn seeds, or cotton seeds.

7. The control method according to claim 1, the method comprising the step of treating the field with the PPO-inhibiting compound after the soybean seeds, corn seeds, or cotton seeds are sowed.

8. The control method according to claim 2, wherein two or more compounds selected from the compound group A is two or more compounds selected from the following compound group A-1.
Compound group A-1:
neonicotinoid compounds: clothianidin, thiamethoxam, imidacloprid, dinotefuran, nitenpyram, acetamiprid, and thiacloprid;
diamide compounds: flubendiamide, chlorantraniliprole, cyantraniliprole, and compounds represented by the formula (II): 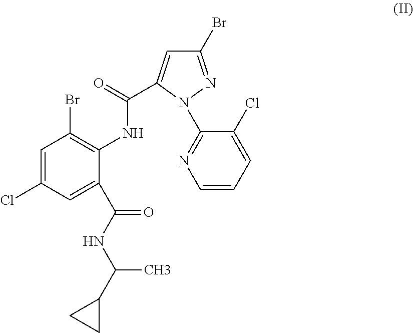 [SMILES: CC(NC(=O)c1cc(Cl)cc(Br)c1NC(=O)c1cc(Br)nn1-c1ncccc1Cl)C1CC1]
carbamate compounds: aldicarb, oxamyl, thiodicarb, carbofuran, carbosulfan, and dimethoate;
organic phosphorous compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
biological nematicidal compounds: Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;
other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
azole compounds: azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizole;
strobilurin compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxy-acetamide (racemic or enantiomer, containing a mixture of R-enantiomer and S-enantiomer (optional ratio));
metalaxyl compounds: metalaxyl and metalaxyl-M;
SDHI compounds: sedaxane, penflufen, carboxin, boscalid, furametpyr, flutolanil, fluxapyroxad, isopyrazam, fluopyram, and thifluzamide;
other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
plant growth regulators: ethephon, chlormequat-chloride, mepiquat-chloride, and 4-oxo-4-(2-phenylethyl)aminobutyric acid

9. The control method according to claim 3, wherein two or more compounds selected from the compound group A is two or more compounds selected from the following compound group A-1.
Compound group A-1:
neonicotinoid compounds: clothianidin, thiamethoxam, imidacloprid, dinotefuran, nitenpyram, acetamiprid, and thiacloprid;
diamide compounds: flubendiamide, chlorantraniliprole, cyantraniliprole, and compounds represented by the formula (II): 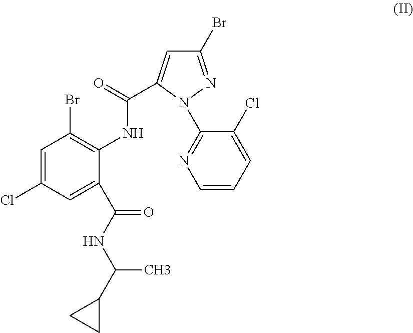 [SMILES: CC(NC(=O)c1cc(Cl)cc(Br)c1NC(=O)c1cc(Br)nn1-c1ncccc1Cl)C1CC1]
carbamate compounds: aldicarb, oxamyl, thiodicarb, carbofuran, carbosulfan, and dimethoate;
organic phosphorous compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
biological nematicidal compounds: Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chiamydosporum, and Arthrobotrys dactyloides;
other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
azole compounds: azaconazole, bitertanol, bromuconazole, cyproconazole, difenoconazole, diniconazole, epoxyconazole, fenbuconazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizole;
strobilurin compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxy-acetamide (racemic or enantiomer, containing a mixture of R-enantiomer and S-enantiomer (optional ratio));
metalaxyl compounds: metalaxyl and metalaxyl-M;
SDHI compounds: sedaxane, penflufen, carboxin, boscalid, furametpyr, flutolanil, fluxapyroxad, isopyrazam, fluopyram, and thifluzamide;
other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
plant growth regulators: ethephon, chlormequat-chloride, mepiquat-chloride, and 4-oxo-4-(2-phenylethyl)aminobutyric acid

10. The control method according to claim 2, the method comprising the step of treating the field with the PPO-inhibiting compound before the soybean seeds, corn seeds, or cotton seeds are sowed.

11. The control method according to claim 3, the method comprising the step of treating the field with the PPO-inhibiting compound before the soybean seeds, corn seeds, or cotton seeds are sowed.

12. The control method according to claim 4, the method comprising the step of treating the field with the PPO-inhibiting compound before the soybean seeds, corn seeds, or cotton seeds are sowed.

13. The control method according to claim 2, the method comprising the step of treating the field with the PPO-inhibiting compound at the same time of sowing the soybean seeds, corn seeds, or cotton seeds.

14. The control method according to claim 3, the method comprising the step of treating the field with the PPO-inhibiting compound at the same time of sowing the soybean seeds, corn seeds, or cotton seeds.

15. The control method according to claim 4, the method comprising the step of treating the field with the PPO-inhibiting compound at the same time of sowing the soybean seeds, corn seeds, or cotton seeds.

16. The control method according to claim 2, the method comprising the step of treating the field with the PPO-inhibiting compound after the soybean seeds, corn seeds, or cotton seeds are sowed.

17. The control method according to claim 3, the method comprising the step of treating the field with the PPO-inhibiting compound after the soybean seeds, corn seeds, or cotton seeds are sowed.

18. The control method according to claim 4, the method comprising the step of treating the field with the PPO-inhibiting compound after the soybean seeds, corn seeds, or cotton seeds are sowed.
